(19) United States
(12) Patent Application Publication
(10) Pub. No.: US 2024/0243886 A1
(43) Pub. Date: Jul. 18, 2024

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Zuomin WU, Dongguan (CN)

(21) Appl. No.: 18/622,326

(22) Filed: Mar. 29, 2024

Related U.S. Application Data
(63) Continuation of application No. PCT/CN2021/122309, filed on Sep. 30, 2021.

(51) Int. Cl. H04L 5/00

(52) U.S. Cl. CPC H04L 5/0053

(57) ABSTRACT

A method for wireless communication, a terminal device, and a network device are provided. The method for wireless communication includes: a terminal device determines a monitoring occasion for a first search space set (SSS) based on first indication information, the first indication information indicating at least one of a configuration of a first control-resource set (CORESET) or a configuration of the first SSS, and the first CORESET being associated with the first SSS; and the terminal device monitors a first control channel based on the monitoring occasion for the first SSS.

### CROSS-REFERENCE TO RELATED APPLICATION

This is a continuation of International Application No. PCT/CN2021/122309, filed on Sep. 30, 2021, the entire content of which is incorporated herein by reference in its entirety.

### BACKGROUND

With the evolution of a New Radio (NR) system, new frequency bands such as 52.6 GHz, 71 GHz or 71 GHz to 114.25 GHz are introduced. The new frequency bands may include licensed spectrums or unlicensed spectrums. In other words, the new frequency bands include both dedicated spectrums and shared spectrums. The Subcarrier spacing (SCS) of the new frequency bands may be greater, for example, the SCS may be 480 kHz or 960 kHz.

### SUMMARY

Embodiments of the present disclosure relate to the field of communications, and in particular, provide a method for wireless communication, a terminal device, and a network device.

In a first aspect, a method for wireless communication is provided. The method includes the following operations.

A terminal device determines a monitoring occasion for a first search space set (SSS) based on first indication information. The first indication information indicates at least one of a configuration of a first control-resource set (CORESET) or a configuration of the first SSS, and the first CORESET is associated with the first SSS.

The terminal device monitors a first control channel based on the monitoring occasion for the first SSS.

In a second aspect, a terminal device is provided. The terminal device is configured to perform the method in the above first aspect.

Specifically, the terminal device includes: a processor, a memory for storing a computer program, and a transceiver. The processor is configured to call the computer program stored in the memory and run the computer program to: determine a monitoring occasion for a first SSS based on first indication information, the first indication information indicating at least one of a configuration of a first CORESET or a configuration of the first SSS, and the first CORESET being associated with the first SSS; and control the transceiver to monitor a first control channel based on the monitoring occasion for the first SSS.

In a third aspect, a network device is provided. Specifically, the network device includes: a processor, a memory for storing a computer program, and a transceiver. The processor is configured to call the computer program stored in the memory and run the computer program to: determine first indication information, the first indication information indicating at least one of a configuration of a first CORESET or a configuration of a first SSS, and the first CORESET being associated with the first SSS; and control the transceiver to transmit the first indication information to a terminal device.

### BRIEF DESCRIPTION OF THE DRAWINGS

FIG. 1A to FIG. 1C are schematic diagrams of application scenarios provided by embodiments of the present disclosure.

FIG. 2 is a schematic diagram of monitoring windows for a Type 0-PDCCH CSS in case of M=½ provided in the present disclosure.

FIG. 3 is a schematic diagram of monitoring windows for a Type 0-PDCCH CSS in case of M=1 provided in the present disclosure.

FIG. 4 is a schematic diagram of monitoring windows for a Type 0-PDCCH CSS in case of M=2 provided in the present disclosure.

FIG. 5 is a schematic flowchart of a method for wireless communication according to an embodiment of the present disclosure.

FIG. 6 is a schematic diagram of two continuous slot groups corresponding to a monitoring windows corresponding to each of SSB i and SSB i+1 in case of M=½ provided by an embodiment of the present disclosure.

FIG. 7 is a schematic diagram of two continuous slot groups corresponding to a monitoring window corresponding to each of SSB i and SSB i+1 in case of M=1 provided by an embodiment of the present disclosure.

FIG. 8 is a schematic diagram of two continuous slot groups corresponding to a monitoring window corresponding to each of SSB i and SSB i+1 in case of M=2 provided by an embodiment of the present disclosure.

FIG. 9 is a schematic diagram of two continuous slots corresponding to a monitoring window corresponding to each of SSB i and SSB i+1 in case of k=1 provided by an embodiment of the present disclosure.

FIG. 10 is a schematic flowchart of another method for wireless communication according to an embodiment of the present disclosure.

FIG. 11 is a schematic block diagram of a terminal device according to an embodiment of the present disclosure.

FIG. 12 is a schematic block diagram of a network device according to an embodiment of the present disclosure.

FIG. 13 is a schematic block diagram of a communication device according to an embodiment of the present disclosure.

FIG. 14 is a schematic block diagram of an apparatus according to an embodiment of the present disclosure.

FIG. 15 is a schematic block diagram of a communication system according to an embodiment of the present disclosure.

### DETAILED DESCRIPTION

The technical solutions of the embodiments of the present disclosure will be described below in combination with the drawings in the embodiments of the present disclosure. It is apparent that the described embodiments are some but not all of the embodiments of the present disclosure. All other embodiments obtained by those of ordinary skill in the art based on the embodiments in the present disclosure without paying creative efforts shall fall within the scope of protection of the present disclosure.

The technical solutions of the embodiments of the present disclosure may be applied to various communication systems, such as, a global system of mobile communication (GSM) system, a code division multiple access (CDMA) system, a wideband code division multiple access (WCDMA) system, a general packet radio service (GPRS), a long term evolution (LTE) system, an advanced LTE (LTE-A) system, an NR system, an evolution system of the NR system, an LTE-based access to unlicensed spectrum (LTE-U) system, an NR-based access to unlicensed spectrum (NR-U) system, a non-terrestrial networks (NTN) system, a universal mobile telecommunication system (UMTS), a wireless local area network (WLAN), Internet of things (IOT), wireless fidelity (WiFi), a 5th generation (5G) system or other communication systems, etc.

In general, traditional communication systems support a limited number of connections and are easy to implement. However, with the development of communication technology, mobile communication systems may not only support traditional communication, but also support, for example, a device to device (D2D) communication, a machine to machine (M2M) communication, a machine type communication (MTC), a vehicle to vehicle (V2V) communication, or a vehicle to everything (V2X) communication, etc. The embodiments of the present disclosure may also be applied to these communication systems.

In some embodiments, the communication system in embodiments of the present disclosure may be applicable to a carrier aggregation (CA) scenario, a dual connectivity (DC) scenario, or a standalone (SA) networking scenario.

In some embodiments, the communication system in the embodiments of the present disclosure may be applicable to an unlicensed spectrum. The unlicensed spectrum may also be considered a shared spectrum. Alternatively, the communication system in the embodiments of the present disclosure may also be applicable to a licensed spectrum, and the licensed spectrum may also be considered as a non-shared spectrum.

In some embodiments, the communication system in the embodiments of the present disclosure may be applicable to an FR1 frequency band (corresponding to a frequency band range of 410 MHz to 7.125 GHZ), and applicable to an FR2 frequency band (corresponding to a frequency band range of 24.25 GHz to 52.6 GHZ), and applicable to new frequency bands such as high frequency bands corresponding to a frequency band range of 52.6 GHz to 71 GHz or a frequency band range of 71 GHz to 114.25 GHz.

In some embodiments, the embodiments of the present disclosure may be applicable to a non-terrestrial networks (NTN) system or to a terrestrial networks (TN) system.

The embodiments of the present disclosure are described in combination with a network device and a terminal device. The terminal device may also be referred to as user equipment (UE), an access terminal, a subscriber unit, a subscriber station, a mobile station, a mobile stage, a remote station, a remote terminal, a mobile device, a user terminal, a terminal, a wireless communication device, a user agent or a user apparatus, etc.

The terminal device may be a STATION (ST) in a WLAN, a cellular telephone, a cordless telephone, a session initiation protocol (SIP) telephone, a wireless local loop (WLL) station, a personal digital assistant (PDA) device, a handheld device and a computing device having a wireless communication function, or other processing device connected to a wireless modem, a vehicle-mounted device, a wearable device, a terminal device in a next generation communication system such as an NR network, or a terminal device in a future evolved public land mobile network (PLMN) network, etc.

In the embodiments of the present disclosure, the terminal device may be deployed on land, including an indoor or outdoor, hand-held, wearable or vehicle-mounted device. It may also be deployed on the water (such as ships, etc.). It may also be deployed in the air (such as airplanes, balloons and satellites, etc.).

In the embodiment of the present disclosure, the terminal device may be a mobile phone, a Pad, a computer with a wireless transceiver function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in a smart city, or a wireless terminal device in a smart home, etc. The terminal device involved in the embodiments of the present disclosure may also be referred to as a terminal, UE, an access terminal device, a vehicle-mounted terminal, an industrial control terminal, a UE unit, a UE station, a mobile station, a mobile stage, a remote station, a remote terminal device, a mobile device, a UE terminal device, a wireless communication device, a UE agent or a UE device, etc. The terminal device may also be fixed or mobile.

By way of example and not limitation, in the embodiments of the present disclosure, the terminal device may also be a wearable device. The wearable device may also be referred to as a wearable smart device, which is the general name of wearable devices developed by applying wearable technology to intelligently design daily wear, such as glasses, gloves, watches, clothing and shoes. The wearable device is a portable device that is worn directly on the body or integrated into clothes or accessories of the user. The wearable device is not only a kind of hardware device, but also realizes powerful functions through software support, data interaction and cloud interaction. Generalized wearable smart devices include as device have characteristics of full functions, large size and realizing complete or partial functions without relying on smart phones, such as a smart watch or smart glasses, and a device that only focus on certain application functions and needs to be used in combination with other devices such as smart phones, for example, various smart bracelets for monitoring physical signs and smart accessories.

In the embodiments of the present disclosure, the network device may be a device for communicating with a mobile device. The network device may be an access point (AP) in a WLAN, a base transceiver station (BTS) in a GSM or CDMA, a NodeB (NB) in a WCDMA, an evolutional node B (Enb or eNodeB) in an LTE, a relay station or an AP, a vehicle-mounted device, a wearable device, a network device (Gnb) in a NR network, a network device in a future evolved PLMN network or a network device in an NTN network, etc.

By way of example and not limitation, in the embodiments of the present disclosure, the network device may have mobility characteristics, for example, the network device may be a mobile device. Alternatively, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, and the like. Alternatively, the network device may also be a base station arranged on land, water and the like.

In the embodiments of the present disclosure, the network device may provide services for a cell. The terminal device communicates with the network device through transmission resources (e.g. frequency domain resources or called spectrum resources) used by the cell. The cell may be a cell corresponding to the network device (e.g. base station), and the cell may belong to a macro base station or a base station corresponding to a Small cell. The Small cell may include a Metro cell, a Micro cell, a Pico cell, a Femto cell, etc. These Small cells have the characteristics of small coverage and low transmission power, and are suitable for providing high-speed data transmission services.

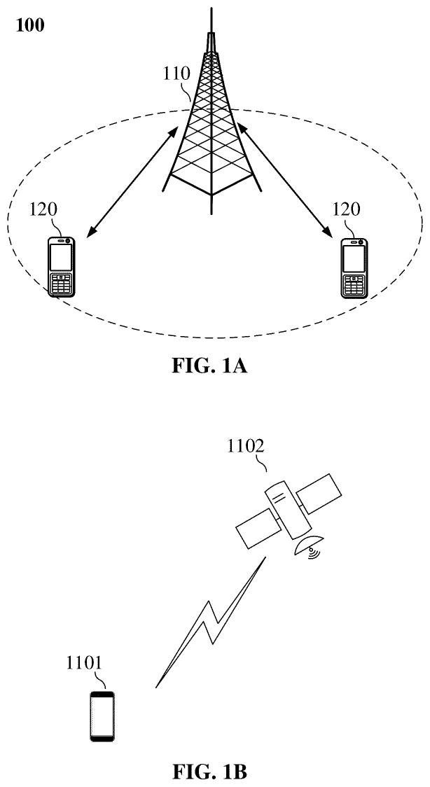

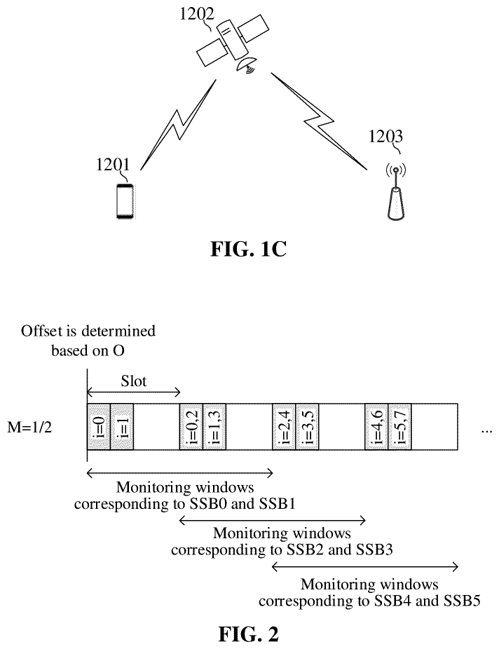

Exemplarily, FIG. 1A is a schematic diagram of an architecture of a communication system provided by an embodiment of the present disclosure. As illustrated in FIG. 1A, the communication system 100 may include a network device 110 which may be a device that communicates with terminal devices 120 (or referred to as a communication terminal or a terminal). The network device 110 may provide communication coverage for a particular geographic area and may communicate with terminal devices located within the coverage area.

FIG. 1A illustrates one network device and two terminal devices as an example. Alternatively, the communication system 100 may include multiple network devices and other numbers of terminal devices may be included within the coverage area of each network device, which is not limited by the embodiments of the present disclosure.

Exemplarily, FIG. 1B is a schematic diagram of an architecture of another communication system provided by an embodiment of the present disclosure. Referring to FIG. 1B, there are a terminal device 1101 and a satellite 1102, and the wireless communication may be performed between the terminal device 1101 and the satellite 1102. The network formed between the terminal device 1101 and the satellite 1102 may also be referred to as an NTN. In the architecture of the communication system illustrated in FIG. 1B, the satellite 1102 may have the function of a base station, and direct communication may be performed between the terminal device 1101 and the satellite 1102. Under this system architecture, the satellite 1102 may be referred to as a network device. Alternatively, multiple network devices 1102 may be included in the communication system and other numbers of terminal devices may be included within the coverage area of each network device 1102, which is not limited in the embodiments of the present disclosure.

Illustratively, FIG. 1C is a schematic diagram of an architecture of another communication system provided by an embodiment of the present disclosure. Referring to FIG. 1C, there are a terminal device 1201, a satellite 1202, and a base station 1203. The wireless communication may be performed between the terminal device 1201 and the satellite 1202, and the communication may be performed between the satellite 1202 and the base station 1203. The network formed among the terminal device 1201, the satellite 1202 and the base station 1203 may also be referred to as an NTN. In the architecture of the communication system illustrated in FIG. 1C, the satellite 1202 may not have the function of a base station, and the communication between the terminal device 1201 and the base station 1203 may be relayed through the satellite 1202. In this system architecture, the base station 1203 may be referred to as a network device. Alternatively, multiple network devices 1203 may be included in the communication system and other numbers of terminal devices may be included within the coverage area of each network device 1203, which is not limited in the embodiments of the present disclosure.

It should be noted that FIG. 1A to FIG. 1C are only illustrative of systems to which the present disclosure applies, and the methods illustrated in the embodiments of the present disclosure may also be applicable to other systems, such as a 5G communication system, an LTE communication system, etc. The embodiments of the present disclosure are not specifically limited thereto.

Alternatively, the wireless communication systems illustrated in FIG. 1A to FIG. 1C may also include other network entities such as a mobility management entity (MME), an access and mobility management function (AMF), etc. The embodiments of the present disclosure are not limited thereto.

It should be understood that a device having a communication function in a network/system in the embodiments of the present disclosure may be referred to as a communication device. Taking the communication system 100 illustrated in FIG. 1A as an example, the communication device may include a network device 110 and a terminal device 120 that have a communication function, and the network device 110 and the terminal device 120 may be specific devices described above, which will not be elaborated herein again. The communication device may also include other devices in the communication system 100, such as a network controller, an MME and other network entities, which is not limited in the embodiments of the present disclosure.

It should be understood that the terms “system” and “network” are often used interchangeably in the present disclosure. In the present disclosure, the term “and/or” is merely used for describing an association relationship between associated objects, which represents that there may be three relationships. For example, A and/or B, which may represent that there are three cases: only A exists, both A and B exist, and only B exists. In addition, the character “/” in the present disclosure generally represents that there is an “or” relationship between the associated objects.

It should be understood that the reference to “indicating” in the embodiments of the present disclosure may represent a direct indication, an indirect indication, or an indication of an association relationship. For example, A indicates B, which may represent that A directly indicates B, for example, B may be obtained through A. It may also represent that A indirectly indicates B, for example, A indicates C, and B may be obtained by C. It may also represent that there is an association relationship between A and B.

In the embodiments of the present disclosure, the operation “configuring” may be implemented by the manner of the network device transmitting indication information to the terminal device.

In the description of the embodiments of the present disclosure, the term “corresponding” may represent that there is a direct correspondence or an indirect correspondence relationship between the two objects, may also represent that there is an association relationship between the two objects, may also represent a relationship of indicating and being indicated, configuring and being configured, etc.

In the embodiments of the present disclosure, the term “predefined” or “pre-configured” may be implemented by pre-storing corresponding codes, tables, or other means that may be used to indicate relevant information in devices (e.g., including the terminal device and the network device), the specific implementation of which is not limited herein. For example, the term “predefined” may refer to being defined in the protocol.

In the embodiments of the present disclosure, the term “protocol” may refer to a standard protocol in the communication field, for example, which may include an LTE protocol, an NR protocol, and related protocols applied in future communication systems, which are not limited in the present disclosure.

In order to facilitate understanding of the technical solutions of the embodiments of the present disclosure, the technical solutions of the present disclosure will be described in detail below by way of specific embodiments. The following related technologies may be taken as optional solutions which may be arbitrarily combined with the technical solutions of the embodiments of the present disclosure, and all of them belong to the scope of protection of the embodiments of the present disclosure. The embodiments of the present disclosure include at least some of the following contents.

With the evolution of the NR system, the research for the NR system may include new frequency bands such as 52.6 GHz, 71 GHz or 71 GHz to 114.25 GHz. The new frequency bands may include licensed spectrums or unlicensed spectrums. In other words, the new frequency bands include dedicated spectrums and shared spectrums. The SCS considered in the new frequency band may be greater than that supported by existing NR systems, for example, the SCS may be 480 kHz or 960 kHz. A duration occupied by each slot is short because of the great SCS. It is an urgent problem to be solved of how to monitor a physical downlink control channel (PDCCH) in the new frequency bands.

In order to better understand the embodiments of the present disclosure, the PDCCH monitoring corresponding to a system information block 1 (SIB1) in the NR system related to the present disclosure is described.

In the NR system, a resource set used to transmit a PDCCH is referred to as a control-resource set (CORESET). A CORESET may include N_{RB} RBs in a frequency domain and N_{symb} symbols in a time domain. N_{RB} and N_{symb} are configured by a network device. One CORESET may be associated with one or more SSSs. One SSS includes one or more control channel elements (CCEs). A terminal device may monitor PDCCH candidates on the CCEs included in the SSS.

In an initial access stage, the terminal device has not established a radio resource control (RRC) connection with the network device, and the terminal device is not configured with a user-specific control channel. The terminal device needs to receive common control information in a cell through a common control channel on an initial downlink band width part (BWP), so as to complete the subsequent initial access process.

For example, the PDCCH transmitted in a common search space (CSS) set of a PDCCH of type 0 (Type 0-PDCCH CSS) is for scheduling a Physical Downlink Shared Channel (PDSCH) carrying the SIB1. The SSS is indicated by a information field of SIB1 configuration of the PDCCH (pdcch-ConfigSIB1) in a master information block (MIB) information, or is configured by RRC signaling such as search space SIB1 (searchSpaceSIB1) or search space zero (searchSpaceZero) in PDCCH common configuration (PD(CH-ConfigCommon). Cyclical redundancy check (CRC) in downlink control information (DCI) format is scrambled by a system information radio network temporary identity (SI-RNTI). The terminal device may monitor a PDCCH candidate according to CORESET 0 associated with the Type0-PDCCH CSS on the corresponding Type0-PDCCH CSS monitoring occasion, thereby receiving the scheduling of the corresponding SIB1 message.

Specifically, the pdcch-ConfigSIB1 information field includes 8 bits, in which 4 bits (e.g. four low bits) indicate the configuration of Type 0-PDCCH CSS and the other 4 bits (e.g. four high bits) indicate the configuration of CORESET 0.

The configuration of the CORESET 0 includes: a multiplexing mode type of a synchronization signal block (SSB) with the CORESET 0, the number of physical resource blocks (PRBs) occupied by the CORESET 0, the number of orthogonal frequency-division multiplexing (OFDM) symbols used for the CORESET 0, and an offset (in a unit of resource block (RB)) between a lower boundary of the SSB and a lower boundary of the CORESET 0 in the frequency domain.

The configuration of the Type 0-PDCCH CSS includes: values of the parameters O and M (for Mode 1 only), an index of the first OFDM symbol in the search space, and the number of search spaces in each slot (for Mode 1 only).

In the Mode 1, the SSB and the CORESET 0 may be mapped on different symbols, and the frequency range of the CORESET 0 needs to include the SSB. The Type 0-PDCCH CSS of an SSB is within a monitoring window containing two continuous slots, and a period of the monitoring window is 20 ms.

In some embodiments, a mapping relationship between an index i of the SSB and the first slot of the monitoring window corresponding to the SSB is illustrated in Formula:

$${n}_{0} = ( O \cdot {2}^{μ} + ⌊ i \cdot M ⌋ ) mod {N}_{slot}^{frame , μ} \qquad Formula 1$$

where n₀ is an index of the first slot, in the monitoring window for the Type0-PDCCH CSS, in a radio frame, and a radio frame is 10 ms. When (0·2^{μ}+[i·M])/Nₛₗₒₜ^{frame,μ}] mod2=0, the index is mapped in the first radio frame in 20 ms. When [(0·2^{μ}+[i·M])/Nₛₗₒₜ^{frame,μ}]]mod2=1, the index is mapped in the second radio frame in 20 ms. Where μ represents a configuration of the SCS, Nₛₗₒₜ^{frame,μ} represents the number of slots included in one radio frame when the SCS is configured to be μ. Table 1 illustrates sizes of the SCSs, the number of slots included in a radio frame (Nₛₗₒₜ^{frame,μ}) and the number of slots included in one subframe (Nₛₗₒₜ^{subframe,μ}) under different configurations of the SCS.

TABLE 1

| μ | SCS | | Nₛₗₒₜ^{frame, μ} | Nₛₗₒₜ^{subframe, μ} |
|---|---|---|---|---|
| 0 | 15 | kHz | 10 | 1 |
| 1 | 30 | kHz | 20 | 2 |
| 2 | 60 | kHz | 40 | 4 |
| 3 | 120 | kHz | 80 | 8 |
| 4 | 240 | kHz | 160 | 16 |
| 5 | 480 | kHz | 320 | 32 |
| 6 | 960 | kHz | 640 | 64 |

The parameter M controls a degree of overlap between a monitoring window corresponding to SSB i and a monitoring window corresponding to SSB i+1. The degree of overlap includes three cases: no overlap (M=2), one slot overlap (M=1) and complete overlap (M=½). The parameter O is used for controlling a starting position of a monitoring window corresponding to the first SSB, to avoid confliction between the monitoring windows for the Type 0-PDCCH CSS and the SSB. The value of O may be {0, 2, 5, 7} for FR1, and value of O may be {0, 2.5, 5, 7.5} for FR2.

For example, when the SCS is 120 kHz, the value of O may be 0, 2.5, 5, and 7.5, and the corresponding offsets are 0 slots, 20 slots, 40 slots, and 60 slots, respectively.

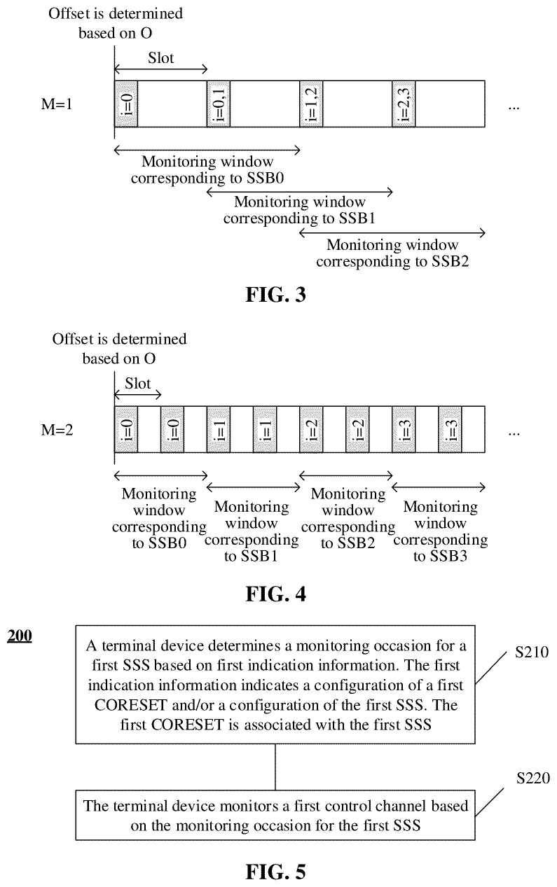

FIG. 2 to FIG. 4 illustrate the schematic diagrams of monitoring windows for the Type 0-PDCCH CSS in three cases: M=½, M=1 and M=2, respectively. When M=½, starting symbols of two search spaces on a slot may be configured as symbols {0, 7} or {0, N_{symb}}. When M=1 or M=2, the starting symbol of the search space on a slot is symbol 0. In FIG. 2, when M=½, it is assumed that the starting symbols of two search spaces on a slot are configured as the symbols {0, N_{symb}}.

It should be noted that the SSB may also be referred to as a synchronization signal/physical broadcast channel block (SS/PBCH block).

In order to better understand the embodiments of the present disclosure, the technical problem to be solved by the present disclosure is described below.

In the high frequency system, a duration occupied by each slot is short due to great SCS. If the manner for monitoring the PDCCH in the existing system is used, the terminal device is required to estimate a channel in CORESET and monitor PDCCH candidates in each slot, which requires high processing capability of the terminal device. In order to reduce the requirement on the processing capability for the terminal device, the Type 0-PDCCH CSS monitored by the terminal device during the initial access process is considered to be enhanced.

Based on the above problem, the present disclosure provides a solution for monitoring a control channel, a configuration of the SSS suitable for the high frequency system is configured in the high frequency system in which the SCS is 480 kHz or 960 kHz during an initial access process or in case of configuring an automatic neighbor cell relation (ANR) function, a solution for monitoring a PDCCH carrying the SIB1 can be optimized. Further, in the high frequency system, when the SCS is 480 kHz or 960 kHz, the requirement on the processing capability for the terminal device can be reduced by enhancing the occasion for monitoring the Type 0-PDCCH CSS by the terminal device from two continuous slots to two continuous slot groups.

The technical solution of the present disclosure will be described in detail by specific embodiments below.

FIG. 5 is a schematic flowchart of a method 200 for wireless communication according to an embodiment of the present disclosure. As illustrated in FIG. 5, the method 200 for wireless communication may include at least some of the following contents.

In operation S210, a terminal device determines a monitoring occasion for a first SSS based on first indication information. The first indication information indicates a configuration of a first CORESET and/or a configuration of the first SSS. The first CORESET is associated with the first SSS.

In operation S220, the terminal device monitors a first control channel based on the monitoring occasion for the first SSS.

In some embodiments, the first indication information is transmitted by the network device. That is, the terminal device receives the first indication information from the network device.

In some embodiments, an SCS corresponding to the first SSS is 480 kHz or 960 kHz. Alternatively, a configuration u of the SCS corresponding to the first SSS is 5 or 6 (as illustrated in above Table 1). The first SSS may also correspond to other SCSs, such as an SCS greater than 960 kHz, which is not limited in the present disclosure.

In some embodiments, the first CORESET includes at least CORESET 0. For example, the first CORESET is CORESET 0. The first CORESET 0 may also include other CORESETs, which are not limited in the present disclosure.

In some embodiments, the first SSS includes at least Type 0-PDCCH CSS. For example, the first SSS is Type 0-PDCCH CSS. The first SSS may also include other search spaces, which are not limited in the present disclosure.

In some embodiments, the first indication information includes pdcch-ConfigSIB1, for example, the first indication information is pdcch-ConfigSIB1. Alternatively, the first indication information is carried in MIB information, or the first indication information is configured by RRC signaling such as searchSpaceSIB1 or searchSpace Zero in PDCCH-ConfigCommon.

In some embodiments, in the high frequency system, a duration occupied by each slot is short due to the great SCS. In order to reduce a capability for monitoring a PDCCH required for the terminal device, the capability of the terminal device to monitor PDCCH candidates may be changed from monitoring on each slot to monitoring on each slot group.

In some embodiments, the configuration of the first SSS includes, but is not limited to, at least one of: a value of a parameter O, a value of a parameter M, the number of first SSSs included in a slot group, or one or more starting positions of one or more first SSSs in a slot group.

Specifically, for example, the first SSS is Type0-PDCCH CSS, and the configuration of the Type0-PDCCH CSS includes at least one of: a value of a parameter O, a value of a parameter M, the number of Type0-PDCCH CSSs included in a slot group, or an index of the first symbol of one or more Type0-PDCCH CSSs in a slot group (for determining a starting symbol of the Type0-PDCCH CSSs in the slot group).

In some embodiments, the parameter O is used for determining a starting position of a monitoring window corresponding to the first SSB, and/or, the parameter M indicates a degree of overlap between a monitoring window corresponding to an i-th SSB and a monitoring window corresponding to an (i+1)-th SSB, and i is an even number. Further, a monitoring window corresponding to a subsequent SSB may be determined based on the parameter O and the parameter M.

In some embodiments, a monitoring window corresponding to one SSB corresponds to one or more continuous slot groups.

In some embodiments, the configuration of the first SSS includes at least one of: the value of the parameter O, the value of the parameter M, the number of first SSSs included in a slot, or one or more starting positions of one or more first SSSs in a slot.

The parameter O is used for determining the starting position of the monitoring window corresponding to the first SSB, the parameter M indicates the degree of overlap between the monitoring window corresponding to the i-th SSB and the monitoring window corresponding to the (i+1)-th SSB, and i is an even number.

The monitoring window corresponding to one SSB corresponds to two continuous slots.

It should be noted that the Type0-PDCCH CSS of one SSB is within a monitoring window containing one or more continuous slot groups. That is, the “monitoring window corresponding to the SSB” may mean that the Type0-PDCCH CSS of the SSB is located in the monitoring window.

In some embodiments, S slots are included in a slot group, and S is a positive integer. For example, S is a positive integer greater than or equal to 2.

Specifically, for example, for a 480 kHz SCS, a slot group includes two slots, or a slot group includes four slots.

Specifically, for another example, for a 960 kHz SCS, a slot group includes two slots, or a slot group includes four slots, or a slot group includes eight slots.

In some embodiments, the parameter M indicates the degree of overlap between the monitoring window corresponding to the i-th SSB and the monitoring window corresponding to the (i+1)-th SSB. The monitoring window corresponding to one SSB corresponds to one or more continuous slot groups. Alternatively, the parameter M is used for indicating at least one of: the monitoring window corresponding to the i-th SSB completely overlapping with the monitoring window corresponding to the (i+1)-th SSB; the monitoring window corresponding to the i-th SSB not overlapping with the monitoring window corresponding to the (i+1)-th SSB at all; or the monitoring window corresponding to the i-th SSB partially overlapping with the monitoring window corresponding to the (i+1)-th SSB. Alternatively, i is an even number.

It should be understood that in an embodiment of the present disclosure, i takes a value starting from 0. For example, when i=0, the i-th SSB refers to SSB0.

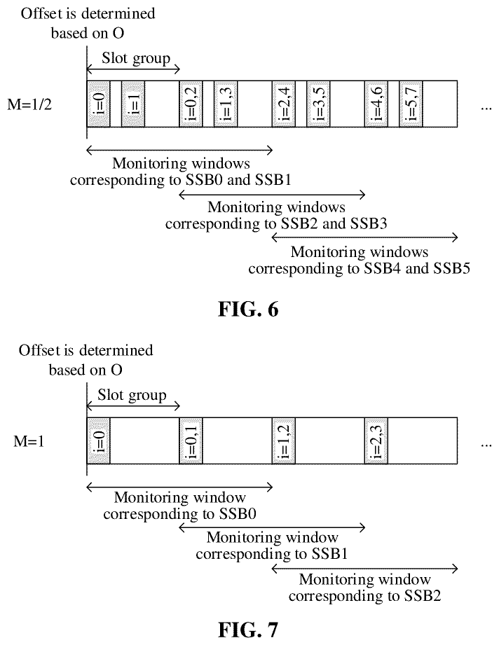

In some embodiments, the parameter M indicates the degree of overlap between the monitoring window corresponding to the i-th SSB and the monitoring window corresponding to the (i+1)-th SSB, and the monitoring window corresponding to one SSB corresponds to two continuous slot groups. M=½ indicates that two continuous slot groups corresponding to the i-th SSB completely overlap with two continuous slot groups corresponding to the (i+1)-th SSB. For example, as illustrated in FIG. 6, two continuous slot groups corresponding to SSB0 completely overlap with two continuous slot groups corresponding to SSB1, two continuous slot groups corresponding to SSB2 completely overlap with two continuous slot groups corresponding to SSB3, and two continuous slot groups corresponding to SSB4 completely overlap with two continuous slot groups corresponding to SSB5. Other SSBs have similar situations and will not be elaborated herein again.

In some embodiments, the parameter M indicates the degree of overlap between the monitoring window corresponding to the i-th SSB and the monitoring window corresponding to the (i+1)-th SSB, and the monitoring window corresponding to one SSB corresponds to two continuous slot groups. M=1 indicates that two continuous slot groups corresponding to the i-th SSB overlap with one of the two continuous slot groups corresponding to the (i+1)-th SSB. For example, as illustrated in FIG. 7, the later one of two continuous slot groups corresponding to SSB0 overlaps with the former one of two continuous slot groups corresponding to SSB1, and the later one of two continuous slot groups corresponding to SSB1 overlaps with the former one of two continuous slot groups corresponding to SSB2. Other SSBs have similar situations and will not be elaborated herein again.

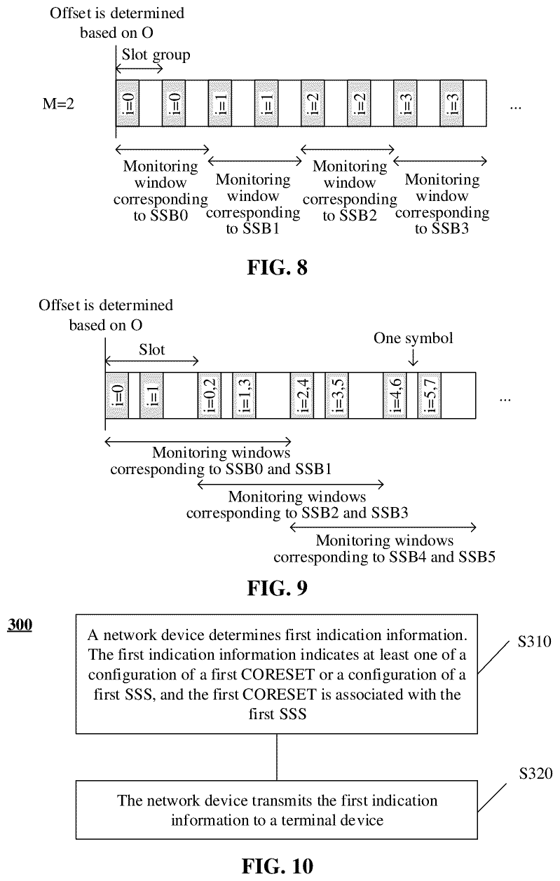

In some embodiments, the parameter M indicates the degree of overlap between the monitoring window corresponding to the i-th SSB and the monitoring window corresponding to the (i+1)-th SSB, and the monitoring window corresponding to one SSB corresponds to two continuous slot groups. M=2 indicates that the two continuous slot groups corresponding to the i-th SSB do not overlap with the two continuous slot groups corresponding to the (i+1)-th SSB at all. For example, as illustrated in FIG. 8, two continuous slot groups corresponding to SSB0 do not overlap with two continuous slot groups corresponding to SSB1, two continuous slot groups corresponding to SSB1 do not overlap with two continuous slot groups corresponding to SSB2, and two continuous slot groups corresponding to SSB2 do not overlap with two continuous slot groups corresponding to SSB3. Other SSBs have similar situations and will not be elaborated herein again.

In some embodiments, when the parameter M indicates that the monitoring window corresponding to the i-th SSB does not overlap with the monitoring window corresponding to the (i+1)-th SSB at all, the monitoring window corresponding to the i-th SSB and the monitoring window corresponding to the (i+1)-th SSB are continuous in the time domain. In other words, an end position of the monitoring window corresponding to the i-th SSB is a starting position of the monitoring window corresponding to the (i+1)-th SSB.

In some embodiments, when the parameter M indicates that the monitoring window corresponding to the i-th SSB does not overlap with the monitoring window corresponding to the (i+1)-th SSB at all, the monitoring window corresponding to the i-th SSB and the monitoring window corresponding to the (i+1)-th SSB are discontinuous in the time domain. In other words, the end position of the monitoring window corresponding to the i-th SSB is separated from the starting position of the monitoring window corresponding to the (i+1)-th SSB by at least one symbol in the time domain.

It should be understood that the network device generally performs beamforming when signal transmission, to resist channel fading and improve the coverage area of the cell. Different beamformings may be adopted for different SSB transmissions. When the terminal device monitors the first SSS (such as Type 0-PDCCH CSS), it should be assumed that the first SSS (such as Type 0-PDCCH CSS) and the SSB corresponding to the first SSS have the same Quasi-co-located (QCL) relationship. Therefore, the first SSSs (such as Type 0-PDCCH CSSs) associated with different SSBs may also correspond to different beamformings. Generally, the time required for beam switching is about 100 ns. Therefore, when the SCS is small, such as 120 kHz, the time for beam switching may be implied in a cyclic prefix (CP) of the symbol. However, when the SCS is large, such as 960 kHz, a length of the CP of a symbol is only about 70 ns, which is not enough for performing beam switching, so it is necessary to reserve a certain gap such as one or more symbols for beam switching.

In some embodiments, in case that at least two first SSSs are included in a slot, any two adjacent first SSSs in the at least two first SSSs are discontinuous in the time domain. That is, any two adjacent first SSSs in the at least two first SSSs are discontinuous in the time domain, which can ensure that a certain gap such as one or more symbols are reserved for beam switching.

In some embodiments, in case that at least two first SSSs are included in a slot group, any two adjacent first SSSs in the at least two first SSSs are discontinuous in the time domain. That is, any two adjacent first SSSs in the at least two first SSSs are discontinuous in the time domain, which can ensure that a certain gap such as one or more symbols are reserved for beam switching.

In some embodiments, an interval between any two adjacent first SSSs in the at least two first SSSs in the time domain is determined by k, k being a positive integer.

In some embodiments, in case that two first SSSs are included in a slot, a configuration of starting positions of the two first SSSs in the slot includes that starting symbols of the two first SSSs are a symbol 0 and a symbol N_{symb}+k, respectively, the N_{symb} representing the number of symbols occupied by the first CORESET. Alternatively, the value of k includes one of 1, 2, and 7.

Specifically, for example, two Type0-PDCCH CSSs are included in a slot, starting symbols of the two Type0-PDCCH CSSs in the slot are configured as the symbols {0, N_{symb}+k}, k being a positive integer, the unit of k being a symbol. Alternatively, k is equal to 1 or 2 or 7.

For example, k=1 is taken as an example. FIG. 9 illustrates an example that two Type0-PDCCH CSSs are included in a slot and the starting symbols of the two Type0-PDCCH CSSs are configured as the symbols {0, N_{symb}+1}.

In some embodiments, in case that two first SSSs are included in a slot group, a configuration of starting positions of the two first SSSs in the slot group includes that the starting symbols of the two first SSSs are a symbol 0 and a symbol N_{symb}+k, respectively, the N_{symb} representing the number of symbols occupied by the first CORESET. Alternatively, the value of k includes one of 1, 2, and 7.

Specifically, for example, two Type0-PDCCH CSSs are included in a slot group and the starting symbols of the two Type0-PDCCH CSSs in the slot group are configured as symbols {0, N_{symb}+k}, k being a positive integer, the unit of k being a symbol. Alternatively, k is equal to 1 or 2 or 7.

In some embodiments, in case that two first SSSs are included in the slot group, a configuration of the starting positions of the two first SSSs in the slot group includes that the starting positions of the two first SSSs are a symbol 0 in a slot n and a symbol 0 in a slot n+k, respectively, the slot n representing the first slot in the slot group. Alternatively, the value of k includes one of 1 and 2.

Specifically, for example, two Type0-PDCCH CSSs are included in a slot group, and the starting symbols of the two Type0-PDCCH CSSs in the slot group are configured as slots {0, k}. That is, the starting positions of the two first SSSs are the symbol 0 of the first slot in the slot group and the symbol 0 of the (k+1)-th slot in the slot group, respectively, k being a positive integer, the unit of k being a slot. Alternatively, k is equal to 1 or 2.

It should be noted that the transmission of the SSB may only occupy the first 40 slots in a radio frame. For the 480 kHz SCS, a radio frame includes 320 slots. For the 960 kHz SCS, a radio frame includes 640 slots. Therefore, a radio frame may include enough slots to transmit the SSB and the monitoring window for the Type 0-PDCCH CSS associated with the SSB. Alternatively, when the Type 0-PDCCH CSS is configured, the number of slots separating the SSB and the monitoring window for the Type 0-PDCCH CSS associated with the SSB may be reduced.

In some embodiments, in case that the SCS corresponding to the first SSS is 480 kHz or 960 kHz, the period of the monitoring window corresponding to the SSB is 10 ms, or the period of the monitoring window corresponding to the SSB is 20 ms. For example, for a 480 kHz or 960 kHz SCS, the period of the monitoring window for the Type 0-PDCCH CSS associated with the SSB is 10 ms. For another example, for a 480 kHz or 960 kHz SCS, the period of the monitoring window for the Type 0-PDCCH CSS associated with the SSB is 20 ms.

In some embodiments, the parameter O is used for determining a starting slot no corresponding to the starting position of the monitoring window corresponding to the first SSB. Specifically, for example, the starting slot n₀ corresponding to the starting position of the monitoring window corresponding to the first SSB may be determined by the following Formula 2.

$${n}_{0} = ( O \cdot {2}^{μ} ) mod {N}_{slot}^{frame , μ} \qquad Formula 2$$

where μ represents a configuration of the SCS corresponding to the first SSS, Nₛₗₒₜ^{frame,μ} represents the number of slots included in a radio frame, and mod represents a modulo operation.

In some embodiments, for example, the first SSB is SSB0.

In some embodiments, the values of μ and Nₛₗₒₜ^{frame,μ} and a correspondence therebetween may be seen in above Table 1, which will not be elaborated herein again.

In some embodiments, the value of the parameter O is {0, 2.5, 5, 7.5} in case that the parameter O is used for determining the starting slot n₀ corresponding to the starting position of the monitoring window corresponding to the first SSB.

For example, when the SCS is 480 kHz, the offset corresponding to the value of O being 0, 2.5, 5 or 7.5 is 0 slot, 80 slots, 160 slots, or 240 slots, respectively.

For another example, when the SCS is 960 kHz, the offset corresponding to the value of O being 0, 2.5, 5 or 7.5 is 0 slot, 160 slots, 320 slots, or 480 slots, respectively.

In some embodiments, the value of the parameter O is {0, 1.25, 2.5, 3.75} in case that the parameter O is used for determining the starting slot n₀ corresponding to the starting position of the monitoring window corresponding to the first SSB.

For example, when the SCS is 480 kHz, the offset corresponding to the value of O being 0, 1.25, 2.5 or 3.75 is 0 slot, 40 slots, 80 slots, or 120 slots, respectively.

For another example, when the SCS is 960 kHz, the offset corresponding to the value of O being 0, 1.25, 2.5 or 3.75 is 0 slot, 80 slots, 160 slots, or 240 slots, respectively.

In some embodiments, the value of the parameter O is {0, 1, 2, 3} in case that the parameter O is used for determining the starting slot n₀ corresponding to the starting position of the monitoring window corresponding to the first SSB.

For example, when the SCS is 480 kHz, the offset corresponding to the value of O being 0, 1, 2 or 3 is 0 slot, 32 slots, 64 slots, or 96 slots, respectively.

For another example, when the SCS is 960 kHz, the offset corresponding to the value of O being 0, 1, 2 or 3 is 0 slot, 64 slots, 128 slots, or 192 slots, respectively.

In some embodiments, the parameter O is used for determining a starting slot group n₀ corresponding to the starting position of the monitoring window corresponding to the first SSB. Specifically, for example, the starting slot group n₀ corresponding to the starting position of the monitoring window corresponding to the first SSB may be determined by the following Formula 3.

$${n}_{0} = ( O \cdot {2}^{μ} ) mod {N}_{slotgroup}^{frame , μ} \qquad Formula 3$$

where μ represents a configuration of the SCS corresponding to the first SSS, N_{slotgroup}^{frame,μ} represents the number of slot groups included in a radio frame, and mod represents a modulo operation.

In some embodiments, N_{slotgroup}^{frame,μ}=floor(Nₛₗₒₜ^{frame,μ}/S) or N_{slotgroup}^{frame,μ}=ceil(Nₛₗₒₜ^{frame,μ}/S).

Nₛₗₒₜ^{frame,μ} represents the number of slots included in the radio frame, S represents slot the number of slots included in a slot group, S is a positive integer, floor represents round down, and ceil represents round up.

In some embodiments, the value of N_{slotgroup}^{frame,μ} slotgroup is 80 in case that the SCS corresponding to the first SSS is 480 kHz or 960 kHz.

In some embodiments, Table 2 illustrates sizes of the SCSs, the number of slots included in a radio frame (Nₛₗₒₜ^{frame,μ}) and the number of slot groups included in a radio frame (N_{slotgroup}^{frame,μ} slotgroup corresponding to different configurations of the SCSs. It is assumed that a slot group includes four slots when the SCS is 480 kHz, and that a slot group includes eight slots when the SCS is 960 kHz.

TABLE 2

| μ | SCS | Nₛₗₒₜ^{frame, μ} | N_{slotgroup}^{frame, μ} |
|---|---|---|---|
| 5 | 480 kHz | 320 | 80 |
| 6 | 960 kHz | 640 | 80 |

In some embodiments, the value of the parameter O is {0, 2.5, 5, 7.5} in case that the parameter O is used for determining the starting slot group n₀ corresponding to the starting position of the monitoring window corresponding to the first SSB.

For example, when the SCS is 480 kHz, the offset corresponding to the value of O being 0, 2.5, 5 or 7.5 is 0 slot group, 20 slot groups, 40 slot groups, or 60 slot groups, respectively. Alternatively, the offset corresponding to the value of O being 0, 2.5, 5 or 7.5 is 0 slot, 80 slots, 160 slots, or 240 slots, respectively.

For another example, when the SCS is 960 kHz, the offset corresponding to the value of O being 0, 2.5, 5 or 7.5 is 0 slot group, 20 slot groups, 40 slot groups, or 60 slot groups, respectively. Alternatively, the offset corresponding to the value of O being 0, 2.5, 5 or 7.5 is 0 slot, 160 slots, 320 slots, or 480 slots, respectively.

In some embodiments, a mapping relationship between an index i of the SSB and the first slot group of a monitoring window corresponding to the index may be determined by the following Formula 4.

$${n}_{i} = ( O \cdot {2}^{μ} + ⌊ i \cdot M ⌋ ) mod {N}_{slotgroup}^{frame , μ} \qquad Formula 4$$

where μ represents that a configuration of the SCS corresponding to the first SSS, N_{slotgroup}^{frame,μ} slotgroup represents the number of slot groups included in a radio frame, and mod represents a modulus operation.

The parameter O is used for determining the starting slot group corresponding to the starting position of the monitoring window corresponding to the first SSB.

The parameter M indicates the degree of overlap between the monitoring window corresponding to the i-th SSB and the monitoring window corresponding to the (i+1)-th SSB.

The monitoring window corresponding to one SSB corresponds to one or more continuous slot groups.

In some embodiments, a configuration of the first CORESET includes, but is not limited to, at least one of: a multiplexing mode of an SSB and the first CORESET, the number N_{RB} of PRBs occupied by the first CORESET, the number N_{symb} of symbols occupied by the first CORESET, or a starting position of the first CORESET in the frequency domain.

Specifically, for example, the first CORESET is CORESET 0, and the configuration of CORESET 0 includes at least one of: a multiplexing mode type of an SSB and the CORESET 0, the number N_{RB} of PRBs occupied by CORESET 0, the number N_{symb} of symbols occupied by CORESET 0, or an offset (in a unit of RB, for determining the starting PRB of CORESET 0 in the frequency domain) between a lower boundary of the SSB and a lower boundary of the CORESET 0 in the frequency domain.

Therefore, in the embodiments of the present disclosure, the solution for monitoring the PDCCH carrying the SIB1 can be optimized by configuring the configuration (for example, the value of the parameter O and the value of the parameter M) of the SSS applicable for the high frequency system. Further, in the embodiments of the present disclosure, in the high frequency system in which the SCS is 480 kHz or 960 kHz during an initial access process or in case of configuring an ANR, the requirement on the processing capability for the terminal device can be reduced by enhancing the occasion for monitoring the Type 0-PDCCH CSS by the terminal device from two continuous slots to two continuous slot groups.

The embodiments in the terminal side of the present disclosure are described in detail above in combination with FIG. 5 to FIG. 9, and the embodiments in the network side of the present disclosure are described in detail below in combination with FIG. 10. It should be understood that embodiments of the network side and the embodiments of the terminal side correspond to each other, and similar descriptions may refer to the embodiments of the terminal side.

FIG. 10 is a schematic flowchart of a method 300 for wireless communication according to an embodiment of the present disclosure. As illustrated in FIG. 10, the method 300 for wireless communication may include at least some of the following contents.

In operation S310, the network device determines first indication information. The first indication information indicates at least one of a configuration of a first CORESET or a configuration of a first SSS, and the first CORESET is associated with the first SSS.

In operation S320, the network device transmits the first indication information to a terminal device.

In some embodiments, an SCS corresponding to the first SSS is 480 kHz or 960 kHz. Alternatively, a configuration μ of the SCS corresponding to the first SSS is 5 or 6 (as illustrated in above Table 1). The first SSS may also correspond to other SCSs, such as an SCS greater than 960 kHz, which is not limited in the present disclosure.

In some embodiments, the first CORESET includes at least CORESET 0. For example, the first CORESET is CORESET 0. The first CORESET 0 may also include other CORESETs, which are not limited in the present disclosure.

In some embodiments, the first SSS includes at least Type 0-PDCCH CSS. For example, the first SSS is Type 0-PDCCH CSS. The first SSS may also include other search spaces, which are not limited in the present disclosure.

In some embodiments, the first indication information includes pdcch-ConfigSIB1, for example, the first indication information is pdcch-ConfigSIB1. Alternatively, the first indication information is carried in MIB information, or the first indication information is configured by RRC signaling such as searchSpaceSIB1 or searchSpace Zero in PDCCH-ConfigCommon.

In some embodiments, in the high frequency system, a duration occupied by each slot is short due to the great SCS. In order to reduce a capability for monitoring the PDCCH required for the terminal device, the capability of the terminal device to monitor PDCCH candidates may be changed from monitoring on each slot to monitoring on each slot group.

In some embodiments, the configuration of the first SSS includes, but is not limited to, at least one of: a value of a parameter O, a value of a parameter M, the number of first SSSs included in a slot group, or one or more starting positions of one or more first SSSs in a slot group.

Specifically, for example, the first SSS is Type0-PDCCH CSS, and the configuration of the Type0-PDCCH CSS includes at least one of: a value of a parameter O, a value of a parameter M, the number of Type0-PDCCH CSSs included in a slot group, or an index of the first symbol of one or more Type0-PDCCH CSSs in a slot group (for determining a starting symbol of the Type0-PDCCH CSSs in the slot group).

In some embodiments, the parameter O is used for determining a starting position of a monitoring window corresponding to the first SSB, and/or, the parameter M indicates a degree of overlap between a monitoring window corresponding to an i-th SSB and a monitoring window corresponding to an (i+1)-th SSB, and i is an even number. Further, a monitoring window corresponding to a subsequent SSB may be determined based on the parameter O and the parameter M.

In some embodiments, a monitoring window corresponding to one SSB corresponds to one or more continuous slot groups.

In some embodiments, the configuration of the first SSS includes at least one of: the value of the parameter O, the value of the parameter M, the number of first SSSs included in a slot, or one or more starting positions of one or more first SSSs in a slot.

The parameter O is used for determining the starting position of the monitoring window corresponding to the first SSB, the parameter M indicates the degree of overlap between the monitoring window corresponding to the i-th SSB and the monitoring window corresponding to the (i+1)-th SSB, and i is an even number.

The monitoring window corresponding to one SSB corresponds to two continuous slots.

It should be noted that the Type0-PDCCH CSS of one SSB is within a monitoring window containing one or more continuous slot groups. That is, the “monitoring window corresponding to the SSB” may mean that the Type0-PDCCH CSS of the SSB is located in the monitoring window.

In some embodiments, S slots are included in a slot group, and S is a positive integer. For example, S is a positive integer greater than or equal to 2.

Specifically, for example, for a 480 kHz SCS, a slot group includes two slots, or a slot group includes four slots.

Specifically, for another example, for a 960 kHz SCS, a slot group includes two slots, or a slot group includes four slots, or a slot group includes eight slots.

In some embodiments, the parameter M indicates the degree of overlap between the monitoring window corresponding to the i-th SSB and the monitoring window corresponding to the (i+1)-th SSB. The monitoring window corresponding to one SSB corresponds to one or more continuous slot groups. Alternatively, the parameter M is used for indicating at least one of: the monitoring window corresponding to the i-th SSB completely overlapping with the monitoring window corresponding to the (i+1)-th SSB; the monitoring window corresponding to the i-th SSB not overlapping with the monitoring window corresponding to the (i+1)-th SSB at all; or the monitoring window corresponding to the i-th SSB partially overlapping with the monitoring window corresponding to the (i+1)-th SSB. Alternatively, i is an even number.

It should be understood that in an embodiment of the present disclosure, i takes a value starting from 0. For example, when i=0, the i-th SSB refers to SSB0.

In some embodiments, the parameter M indicates the degree of overlap between the monitoring window corresponding to the i-th SSB and the monitoring window corresponding to the (i+1)-th SSB, and the monitoring window corresponding to one SSB corresponds to two continuous slot groups. M=½ indicates that two continuous slot groups corresponding to the i-th SSB completely overlap with two continuous slot groups corresponding to the (i+1)-th SSB. For example, as illustrated in FIG. 6, two continuous slot groups corresponding to SSB0 completely overlap with two continuous slot groups corresponding to SSB1, two continuous slot groups corresponding to SSB2 completely overlap with two continuous slot groups corresponding to SSB3, and two continuous slot groups corresponding to SSB4 completely overlap with two continuous slot groups corresponding to SSB5. Other SSBs have similar situations and will not be elaborated herein again.

In some embodiments, the parameter M indicates the degree of overlap between the monitoring window corresponding to the i-th SSB and the monitoring window corresponding to the (i+1)-th SSB, and the monitoring window corresponding to one SSB corresponds to two continuous slot groups. M=1 indicates that two continuous slot groups corresponding to the i-th SSB overlap with one of the two continuous slot groups corresponding to the (i+1)-th SSB. For example, as illustrated in FIG. 7, the later one of two continuous slot groups corresponding to SSB0 overlaps with the former one of two continuous slot groups corresponding to SSB1, and the later one of two continuous slot groups corresponding to SSB1 overlaps with the former one of two continuous slot groups corresponding to SSB2. Other SSBs have similar situations and will not be elaborated herein again.

In some embodiments, the parameter M indicates the degree of overlap between the monitoring window corresponding to the i-th SSB and the monitoring window corresponding to the (i+1)-th SSB, and the monitoring window corresponding to one SSB corresponds to two continuous slot groups. M=2 indicates that the two continuous slot groups corresponding to the i-th SSB do not overlap with the two continuous slot groups corresponding to the (i+1)-th SSB at all. For example, as illustrated in FIG. 8, two continuous slot groups corresponding to SSB0 do not overlap with two continuous slot groups corresponding to SSB1, two continuous slot groups corresponding to SSB1 do not overlap with two continuous slot groups corresponding to SSB2, and two continuous slot groups corresponding to SSB2 do not overlap with two continuous slot groups corresponding to SSB3. Other SSBs have similar situations and will not be elaborated herein again.

In some embodiments, when the parameter M indicates that the monitoring window corresponding to the i-th SSB does not overlap with the monitoring window corresponding to the (i+1)-th SSB at all, the monitoring window corresponding to the i-th SSB and the monitoring window corresponding to the (i+1)-th SSB are continuous in the time domain. In other words, an end position of the monitoring window corresponding to the I-th SSB is a starting position of the monitoring window corresponding to the (i+1)-th SSB.

In some embodiments, when the parameter M indicates that the monitoring window corresponding to the i-th SSB does not overlap with the monitoring window corresponding to the (i+1)-th SSB at all, the monitoring window corresponding to the i-th SSB and the monitoring window corresponding to the (i+1)-th SSB are discontinuous in the time domain. In other words, the end position of the monitoring window corresponding to the i-th SSB is separated from the starting position of the monitoring window corresponding to the (i+1)-th SSB by at least one symbol in the time domain.

It should be understood that the network device generally performs beamforming during signal transmission to resist channel fading and improve the coverage area of the cell. Different beamformings may be adopted for different SSB transmissions. When the terminal device monitors the first SSS (such as Type 0-PDCCH CSS), it should be assumed that the first SSS (such as Type 0-PDCCH CSS) and the SSB corresponding to the first SSS have the same QCL relationship. Therefore, the first SSSs (such as Type 0-PDCCH CSSs) associated with different SSBs may also correspond to different beamformings. Generally, the time required for beam switching is about 100 ns. Therefore, when the SCS is small, such as 120 kHz, the time for beam switching may be implied in a CP of the symbol. However, when the SCS is large, such as 960 kHz, a length of the CP of a symbol is only about 70 ns, which is not enough for performing beam switching, so it is necessary to reserve a certain gap such as one or more symbols for beam switching.

In some embodiments, in case that at least two first SSSs are included in a slot, any two adjacent first SSSs in the at least two first SSSs are discontinuous in the time domain. That is, any two adjacent first SSSs in the at least two first SSSs are discontinuous in the time domain, which can ensure that a certain gap such as one or more symbols are reserved for beam switching.

In some embodiments, in case that at least two first SSSs are included in a slot group, any two adjacent first SSSs in the at least two first SSSs are discontinuous in the time domain. That is, any two adjacent first SSSs in the at least two first SSSs are discontinuous in the time domain, which can ensure that a certain gap such as one or more symbols are reserved for beam switching.

In some embodiments, an interval between any two adjacent first SSSs in the at least two first SSSs in the time domain is determined by k, k being a positive integer.

In some embodiments, in case that two first SSSs are included in the slot, a configuration of starting positions of the two first SSSs in the slot includes that starting symbols of the two first SSSs are a symbol 0 and a symbol N_{symb}+k, respectively, the N_{symb} representing the number of symbols occupied by the first CORESET. Alternatively, the value of k includes one of 1, 2, and 7.

Specifically, for example, two Type0-PDCCH CSSs are included in a slot, the starting symbols of the two Type0-PDCCH CSSs in the slot are configured as the symbols {0, N_{symb}+k}, k being a positive integer, the unit of k being a symbol. Alternatively, k is equal to 1 or 2 or 7.

For example, k=1 is taken as an example. FIG. 9 illustrates an example that two Type0-PDCCH CSSs are included in a slot and the starting symbols of the two Type0-PDCCH CSSs are configured as the symbols {0, N_{symb}+1}.

In some embodiments, in case that two first SSSs are included in a slot group, a configuration of starting positions of the two first SSSs in the slot group includes that the starting symbols of the two first SSSs are a symbol 0 and a symbol N_{symb}+k, respectively, the N_{symb} representing the number of symbols occupied by the first CORESET. Alternatively, the value of k includes one of 1, 2, and 7.

Specifically, for example, two Type0-PDCCH CSSs are included in a slot group and the starting symbols of the two Type0-PDCCH CSSs in the slot group are configured as symbols {0, N_{symb}+k}, k being a positive integer, the unit of k being a symbol. Alternatively, k is equal to 1 or 2 or 7.

In some embodiments, in case that two first SSSs are included in the slot group, a configuration of the starting positions of the two first SSSs in the slot group includes that the starting positions of the two first SSSs are a symbol 0 in a slot n and a symbol 0 in a slot n+k, respectively, the slot n representing the first slot in the slot group. Alternatively, the value of k includes one of 1 and 2.

Specifically, for example, two Type0-PDCCH CSSs are included in a slot group, and the starting symbols of the two Type0-PDCCH CSSs in the slot group are configured as slots {0, k}. That is, the starting positions of the two first SSSs are the symbol 0 of the first slot in the slot group and the symbol 0 of the (k+1)-th slot in the slot group, respectively, k being a positive integer, the unit of k being a slot. Alternatively, k is equal to 1 or 2.

It should be noted that the transmission of the SSB may only occupy the first 40 slots in a radio frame. For the 480 kHz SCS, a radio frame includes 320 slots. For the 960 kHz SCS, a radio frame includes 640 slots. Therefore, a radio frame may include enough slots to transmit the SSB and the monitoring window for the Type 0-PDCCH CSS associated with the SSB. Alternatively, when the Type 0-PDCCH CSS is configured, the number of slots spaced between the SSB and the monitoring window for the Type 0-PDCCH CSS associated with the SSB may be reduced.

In some embodiments, in case that the SCS corresponding to the first SSS is 480 kHz or 960 kHz, the period of the monitoring window corresponding to the SSB is 10 ms, or the period of the monitoring window corresponding to the SSB is 20 ms. For example, for a 480 kHz or 960 kHz SCS, the period of the monitoring window for the Type 0-PDCCH CSS associated with the SSB is 10 ms. For another example, for a 480 kHz or 960 kHz SCS, the period of the monitoring window for the Type 0-PDCCH CSS associated with the SSB is 20 ms.

In some embodiments, the parameter O is used for determining a starting slot no corresponding to the starting position of the monitoring window corresponding to the first SSB. Specifically, for example, the starting slot n₀ corresponding to the starting position of the monitoring window corresponding to the first SSB may be determined by the following Formula 2.

$${n}_{0} = ( O \cdot {2}^{μ} ) mod {N}_{slot}^{frame , μ} \qquad Formula 2$$

where μ represents a configuration of the SCS corresponding to the first SSS, Nₛₗₒₜ^{frame,μ} represents the number of slots included in a radio frame, and mod represents a modulo operation.

In some embodiments, for example, the first SSB is SSB0.

In some embodiments, the values of μ and Nₛₗₒₜ^{frame,μ} and a correspondence slot therebetween may be seen in above Table 1, which will not be elaborated herein again.

In some embodiments, the value of the parameter O is {0, 2.5, 5, 7.5} in case that the parameter O is used for determining the starting slot n₀ corresponding to the starting position of the monitoring window corresponding to the first SSB.

For example, when the SCS is 480 kHz, the offset corresponding to the value of O being 0, 2.5, 5 or 7.5 is 0 slot, 80 slots, 160 slots, or 240 slots, respectively.

For another example, when the SCS is 960 kHz, the offset corresponding to the value of O being 0, 2.5, 5 or 7.5 is 0 slot, 160 slots, 320 slots, or 480 slots, respectively.

In some embodiments, the value of the parameter O is {0, 1.25, 2.5, 3.75} in case that the parameter O is used for determining the starting slot n₀ corresponding to the starting position of the monitoring window corresponding to the first SSB.

For example, when the SCS is 480 kHz, the offset corresponding to the value of O being 0, 1.25, 2.5 or 3.75 is 0 slot, 40 slots, 80 slots, or 120 slots, respectively.

For another example, when the SCS is 960 kHz, the offset corresponding to the value of O being 0, 1.25, 2.5 or 3.75 is 0 slot, 80 slots, 160 slots, or 240 slots, respectively.

In some embodiments, the value of the parameter O is {0, 1, 2, 3} in case that the parameter O is used for determining the starting slot n₀ corresponding to the starting position of the monitoring window corresponding to the first SSB.

For example, when the SCS is 480 kHz, the offset corresponding to the value of O being 0, 1, 2 or 3 is 0 slot, 32 slots, 64 slots, or 96 slots, respectively.

For other example, when the SCS is 960 kHz, the offset corresponding to the value of O being 0, 1, 2 or 3 is 0 slot, 64 slots, 128 slots, or 192 slots, respectively.

In some embodiments, the parameter O is used for determining a starting slot group n₀ corresponding to the starting position of the monitoring window corresponding to the first SSB. Specifically, for example, the starting slot group n₀ corresponding to the starting position of the monitoring window corresponding to the first SSB may be determined by the following Formula 3.

$${n}_{0} = ( O \cdot {2}^{μ} ) mod {N}_{slotgroup}^{frame , μ} \qquad Formula 3$$

where μ represents a configuration of the SCS corresponding to the first SSS, N_{slotgroup}^{frame,μ} represents the number of slot groups included in a radio frame, and mod represents a modulo operation.

In some embodiments, N_{slotgroup}^{frame,μ}=floor (Nₛₗₒₜ^{frame,μ}/S) or N_{slotgroup}^{frame,μ}=ceil(Nₛₗₒₜ^{frame,μ}/S).

Nₛₗₒₜ^{frame,μ} slot represents the number of slots included in the radio frame, S represents the number of slots included in a slot group, S is a positive integer, floor represents round down, and ceil represents round up.

In some embodiments, the value of N_{slotgroup}^{frame,μ} is 80 in case that the SCS corresponding to the first SSS is 480 kHz or 960 kHz.

In some embodiments, Table 2 illustrates sizes of the SCSs, the number of slots included in a radio frame (Nₛₗₒₜ^{frame,μ}) and the number of slot groups included in a radio frame (Nₛₗₒₜ^{frame,μ} slotgroup) corresponding to different configurations of the SCSs. It is assumed that a slot group includes four slots when the SCS is 480 kHz, and a slot group includes eight slots when the SCS is 960 kHz.

TABLE 2

| μ | SCS | Nₛₗₒₜ^{frame, μ} | N_{slotgroup}^{frame, μ} |
|---|---|---|---|
| 5 | 480 kHz | 320 | 80 |
| 6 | 960 kHz | 640 | 80 |

In some embodiments, the value of the parameter O is {0, 2.5, 5, 7.5} in case that the parameter O is used for determining the starting slot group n₀ corresponding to the starting position of the monitoring window corresponding to the first SSB.

For example, when the SCS is 480 kHz, the offset corresponding to the value of O being 0, 2.5, 5 or 7.5 is 0 slot group, 20 slot groups, 40 slot groups, or 60 slot groups, respectively. Alternatively, the offset corresponding to the value of O being 0, 2.5, 5 or 7.5 is 0 slot, 80 slots, 160 slots, or 240 slots, respectively.

For another example, when the SCS is 960 kHz, the offset corresponding to the value of O being 0, 2.5, 5 or 7.5 is 0 slot group, 20 slot groups, 40 slot groups, or 60 slot groups, respectively. Alternatively, the offset corresponding to the value of O being 0, 2.5, 5 or 7.5 is 0 slot, 160 slots, 320 slots, or 480 slots, respectively.

In some embodiments, a mapping relationship between an index i of the SSB and the first slot group of a monitoring window corresponding to the index may be determined by the following Formula 4.

$${n}_{i} = ( O \cdot {2}^{μ} + ⌊ i \cdot M ⌋ ) mod {N}_{slotgroup}^{frame , μ} \qquad Formula 4$$

where μ represents that a configuration of the SCS corresponding to the first SSS, N_{slotgroup}^{frame,μ} represents the number of slot groups included in a radio frame, and mod represents a modulus operation.

The parameter O is used for determining the starting slot group corresponding to the starting position of the monitoring window corresponding to the first SSB.

The parameter M indicates the degree of overlap between the monitoring window corresponding to the i-th SSB and the monitoring window corresponding to the (i+1)-th SSB.

The monitoring window corresponding to one SSB corresponds to one or more continuous slot groups.

In some embodiments, a configuration of the first CORESET includes, but is not limited to, at least one of: a multiplexing mode of an SSB and the first CORESET, the number N_{RB} of PRBs occupied by the first CORESET, the number N_{symb} of symbols occupied by the first CORESET, or a starting position of the first CORESET in the frequency domain.

Specifically, for example, the first CORESET is CORESET 0, and the configuration of CORESET 0 includes at least one of: a multiplexing mode type of an SSB and the CORESET 0, the number N_{RB} of PRBs occupied by CORESET 0, the number N_{symb} of symbols occupied by CORESET 0, or an offset (in a unit of RB, for determining the starting PRB of CORESET 0 in the frequency domain) between a lower boundary of the SSB and a lower boundary of the CORESET 0 in the frequency domain.

Therefore, in the embodiments of the present disclosure, the solution for monitoring the PDCCH carrying the SIB1 can be optimized by configuring the configuration (for example, the value of the parameter O and the value of the parameter M) of the SSS applicable for the high frequency system. Further, in the embodiments of the present disclosure, in the high frequency system in which the SCS is 480 kHz or 960 kHz during an initial access process or in case of configuring an ANR, the requirement on the processing capability for the terminal device can be reduced by enhancing the occasions for monitoring the Type 0-PDCCH CSS by the terminal device from two continuous slots to two continuous slot groups.

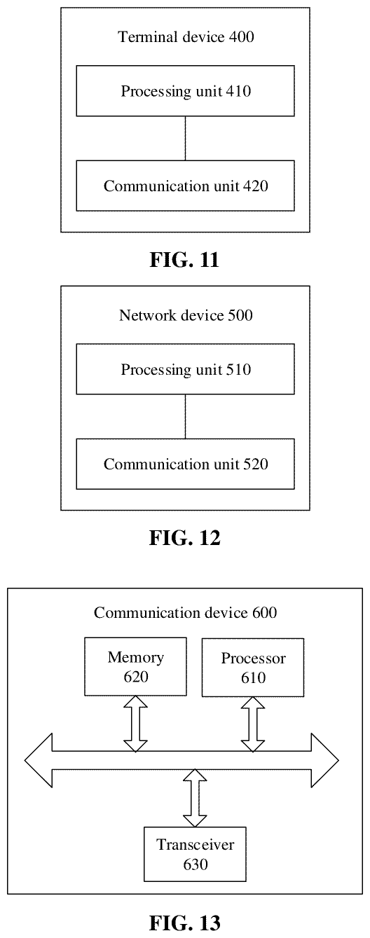

The method embodiments of the present disclosure are described in detail above in combination with FIG. 5 to FIG. 10, and the device embodiments of the present disclosure are described in detail below in combination with FIG. 11 to FIG. 12. It should be understood that the apparatus embodiments and the method embodiments correspond to each other, and similar descriptions may refer to the method embodiments.

FIG. 11 illustrates a schematic block diagram of a terminal device 400 according to an embodiment of the present disclosure. As illustrated in FIG. 11, the terminal device 400 includes a processing unit 410 and a communication unit 420.

The processing unit is configured to determine a monitoring occasion for the first SSS based on first indication information. The first indication information indicates at least one of a configuration of a first CORESET or a configuration of the first SSS, and the first CORESET is associated with the first SSS.

The communication unit is configured to monitor a first control channel based on the monitoring occasion for the first SSS.

In some embodiments, the configuration of the first SSS includes at least one of: a value of a parameter O, a value of a parameter M, a number of first SSSs included in a slot group, or one or more starting positions of one or more first SSSs in a slot group.

In some embodiments, the parameter O is used for determining a starting position of a monitoring window corresponding to the first SSB, and/or, the parameter M indicates a degree of overlap between a monitoring window corresponding to an i-th SSB and a monitoring window corresponding to an (i+1)-th SSB, i being an even number.

In some embodiments, a monitoring window corresponding to an SSB corresponds to one or more continuous slot groups.

In some embodiments, the parameter M indicates the degree of overlap between the monitoring window corresponding to the i-th SSB and the monitoring window corresponding to the (i+1)-th SSB. The monitoring window corresponding to an SSB corresponds to one or more continuous slot groups.

Specifically, M=½ indicates that two continuous slot groups corresponding to the i-th SSB completely overlap with two continuous slot groups corresponding to the (i+1)-th SSB.

Alternatively, M=1 indicates that two continuous slot groups corresponding to the i-th SSB overlap with one of two continuous slot groups corresponding to the (i+1)-th SSB.

Alternatively, M=2 indicates that the two continuous slot groups corresponding to the i-th SSB do not overlap with the two continuous slot groups corresponding to the (i+1)-th SSB at all.

In some embodiments, a slot group includes S slots, S being a positive integer.

In some embodiments, the configuration of the first SSS includes at least one of: a value of a parameter O, a value of a parameter M, a number of first SSSs included in a slot, or one or more starting positions of one or more first SSSs in a slot.

The parameter O is used for determining a starting position of a monitoring window corresponding to a first SSB, the parameter M indicates a degree of overlap between a monitoring window corresponding to an i-th SSB and a monitoring window corresponding to an (i+1)-th SSB, i being an even number.

A monitoring window corresponding to an SSB corresponds to two continuous slots.

In some embodiments, in case that at least two first SSSs are included in a slot, any two adjacent first SSSs in the at least two first SSSs are discontinuous in a time domain.

Alternatively, in case that at least two first SSSs are included in a slot group, any two adjacent first SSSs in the at least two first SSSs are discontinuous in a time domain.

In some embodiments, an interval between any two adjacent first SSSs in the at least two first SSSs in the time domain is determined by k, k being a positive integer.

In some embodiments, in case that two first SSSs are included in the slot, a configuration of starting positions of the two first SSSs in the slot includes: starting symbols of the two first SSSs being a symbol 0 and a symbol N_{symb}+k, respectively, the N_{symb} representing a number of symbols occupied by the first CORESET.

In some embodiments, in case that two first SSSs are included in the slot group, a configuration of starting positions of the two first SSSs in the slot group includes: starting symbols of the two first SSSs being a symbol 0 and a symbol N_{symb}+k, respectively, the N_{symb} representing a number of symbols occupied by the first CORESET.

In some embodiments, a value of k includes one of: 1, 2 and 7.

In some embodiments, in case that two first SSSs are included in the slot group, a configuration of starting positions of the two first SSSs in the slot group includes: the starting positions of the two first SSSs being a symbol 0 in a slot n and a symbol 0 in a slot n+k, respectively, the slot n representing a first slot in the slot group.

In some embodiments, a value of k includes one of 1 and 2.

In some embodiments, the parameter O is used for determining a starting slot no corresponding to a starting position of a monitoring window corresponding to the first SSB, where,

$${n}_{0} = ( O \cdot {2}^{μ} ) mod {N}_{slotgroup}^{frame , μ} .$$

In the above formula, μ represents a configuration of an SCS corresponding to the first SSS, Nₛₗₒₜ^{frame,μ} represents a number of slots included in a radio frame, and mod represents a modulo operation.

In some embodiments, a value of the parameter O is {0, 2.5, 5, 7.5}.

Alternatively, a value of the parameter O is {0, 1.25, 2.5, 3.75}.

Alternatively, a value of the parameter O is {0, 1, 2, 3}.

In some embodiments, the parameter O is used for determining a starting slot group n₀ corresponding to a starting position of a monitoring window corresponding to the first SSB, where,

$${n}_{0} = ( O \cdot {2}^{μ} ) mod {N}_{slotgroup}^{frame , μ} .$$

In the above formula, μ represents a configuration of an SCS corresponding to the first SSS, N_{slotgroup}^{frame,μ} represents a number of slot groups included in a radio frame, and mod represents a modulo operation.

In some embodiments, N_{slotgroup}^{frame,μ}=floor(Nₛₗₒₜ^{frame,μ}/S), or N_{slotgroup}^{frame,μ}=ceil(Nₛₗₒₜ^{frame,μ}/S).

In the above formulas, Nₛₗₒₜ^{frame,μ} represents a number of slots included in the radio frame, S represents a number of slots included in a slot group, S being a positive integer, floor represents round down, and ceil represents round up.

In some embodiments, in case that the SCS corresponding to the first SSS is 480 kHz or 960 kHz, a value of N_{slotgroup}^{frame,μ} is 80.

In some embodiments, the value of the parameter O is {0, 2.5, 5, 7.5}.

In some embodiments, in case that an SCS corresponding to the first SSS is 480 kHz or 960 kHz, a period of a monitoring window corresponding to an SSB is 10 ms, or a period of a monitoring window corresponding to an SSB is 20 ms.

In some embodiments, the configuration of the first CORESET includes at least one of: a multiplexing mode of an SSB and the first CORESET, a number of PRBs occupied by the first CORESET, a number of symbols occupied by the first CORESET, or a starting position of the first CORESET in a frequency domain.

In some embodiments, the first COREST includes CORESET 0, and/or the first SSS includes Type 0-PDCCH CSS.

In some embodiments, the first indication information includes pdcch-ConfigSIB1, and the first indication information is carried in MIB information, or the first indication information is configured through searchSpaceSIB1 or searchSpaceZero in PDCCH-ConfigCommon.

In some embodiments, an SCS corresponding to the first SSS is 480 kHz or 960 kHz.

Alternatively, a configuration μ of an SCS corresponding to the first SSS is 5 or 6.

In some embodiments, the above communication unit may be a communication interface, a transceiver or an input-output interface of a communication chip or a system-on-chip. The processing unit may be one or more processors.

It should be understood that the terminal device 400 according to the embodiment of the present disclosure may correspond to the terminal device in the method embodiments of the present disclosure, and the above and other operations and/or functions of the various units in the terminal device 400 are for implementing the corresponding flows of the terminal device in the method 200 illustrated in FIG. 5, which are not elaborated herein for the sake of brevity.

FIG. 12 illustrates a schematic block diagram of a network device 500 according to an embodiment of the present disclosure. As illustrated in FIG. 12, the network device 500 includes a processing unit 510 and a communication unit 520.

The processing unit 510 is configured to determine first indication information.

The first indication information indicates at least one of a configuration of a first CORESET or a configuration of a first SSS, and the first CORESET is associated with the first SSS.

The communication unit 520 is configured to transmit the first indication information to a terminal device.

In some embodiments, the configuration of the first SSS includes at least one of: a value of a parameter O, a value of a parameter M, a number of first SSSs included in a slot group, or one or more starting positions of one or more first SSSs in a slot group.

In some embodiments, the parameter O is used for determining a starting position of a monitoring window corresponding to a first SSB, and/or the parameter M indicates a degree of overlap between a monitoring window corresponding to an i-th SSB and a monitoring window corresponding to an (i+1)-th SSB, i being an even number.

In some embodiments, a monitoring window corresponding to an SSB corresponds to one or more continuous slot groups.

In some embodiments, the parameter M indicates a degree of overlap between a monitoring window corresponding to an i-th SSB and a monitoring window corresponding to an (i+1)-th SSB, and a monitoring window corresponding to an SSB corresponds to two continuous slot groups.

Specifically, M=½ indicates that two continuous slot groups corresponding to the i-th SSB completely overlap with two continuous slot groups corresponding to the (i+1)-th SSB.

Alternatively, M=1 indicates that two continuous slot groups corresponding to the i-th SSB overlap with one of two continuous slot groups corresponding to the (i+1)-th SSB.

Alternatively, M=2 indicates that two continuous slot groups corresponding to the i-th SSB do not overlap with two continuous slot groups corresponding to the (i+1)-th SSB at all.

In some embodiments, a slot group includes S slots, S being a positive integer.

In some embodiments, the configuration of the first SSS includes at least one of: a value of a parameter O, a value of a parameter M, a number of first SSSs included in a slot, or one or more starting positions of one or more first SSSs in a slot.

The parameter O is used for determining a starting position of a monitoring window corresponding to a first SSB, and the parameter M indicates a degree of overlap between a monitoring window corresponding to an i-th SSB and a monitoring window corresponding to an (i+1)-th SSB, i being an even number.

A monitoring window corresponding to an SSB corresponds to two continuous slots.

In some embodiments, in case that at least two first SSSs are included in a slot, any two adjacent first SSSs in the at least two first SSSs are discontinuous in a time domain.

Alternatively, in case that at least two first SSSs are included in a slot group, any two adjacent first SSSs in the at least two first SSSs are discontinuous in a time domain.

In some embodiments, an interval between any two adjacent first SSSs in the at least two first SSSs in the time domain is determined by k, k being a positive integer.

In some embodiments, in case that two first SSSs are included in the slot, a configuration of starting positions of the two first SSSs in the slot includes: starting symbols of the two first SSSs being a symbol 0 and a symbol N_{symb}+k, respectively, the N_{symb} representing a number of symbols occupied by the first CORESET.

In some embodiments, in case that two first SSSs are included in the slot group, a configuration of starting positions of the two first SSSs in the slot group includes: starting symbols of the two first SSSs being a symbol 0 and a symbol N_{symb}+k, respectively, the N_{symb} representing a number of symbols occupied by the first CORESET.

In some embodiments, a value of k includes one of: 1, 2 and 7.

In some embodiments, in case that two first SSSs are included in the slot group, a configuration of starting positions of the two first SSSs in the slot group includes: the starting positions of the two first SSSs being a symbol 0 in a slot n and a symbol 0 in a slot n+k, respectively, the slot n representing a first slot in the slot group.

In some embodiments, a value of k includes one of 1 and 2.

In some embodiments, the parameter O is used for determining a starting slot no corresponding to a starting position of a monitoring window corresponding to a first SSB, where,

$${n}_{0} = ( O \cdot {2}^{μ} ) mod {N}_{slotgroup}^{frame , μ} .$$

In the above formula, μ represents a configuration of an SCS corresponding to the first SSS, Nₛₗₒₜ^{frame,μ} represents a number of slots included in a radio frame, and mod represents a modulo operation.

In some embodiments, a value of the parameter O is {0, 2.5, 5, 7.5}.

Alternatively, a value of the parameter O is {0, 1.25, 2.5, 3.75}.

Alternatively, a value of the parameter O is {0, 1, 2, 3}.

In some embodiments, the parameter O is used for determining a starting slot group n₀ corresponding to a starting position of a monitoring window corresponding to a first SSB, where,

$${n}_{0} = ( O \cdot {2}^{μ} ) mod {N}_{slotgroup}^{frame , μ} .$$

In the above formula, μ represents a configuration of an SCS corresponding to the first SSS, N_{slotgroup}^{frame,μ} represents a number of slot groups included in a radio frame, and mod represents a modulo operation.

In some embodiments, N_{slotgroup}^{frame,μ}=floor(Nₛₗₒₜ^{frame,μ}/S), or N_{slotgroup}^{frame,μ}=ceil(Nₛₗₒₜ^{frame,μ}/S).

In the above formulas, Nₛₗₒₜ^{frame,μ} represents a number of slots included in the radio frame, and S represents a number of slots included in a slot group, S is a positive integer, floor represents round down, and ceil represents round up.

In some embodiments, in case that the SCS corresponding to the first SSS is 480 kHz or 960 kHz, a value of N_{slotgroup}^{frame,μ} slotgroup is 80.

In some embodiments, the value of the parameter O is {0, 2.5, 5, 7.5}.

In some embodiments, in case that an SCS corresponding to the first SSS is 480 kHz or 960 kHz, a period of a monitoring window corresponding to an SSB is 10 ms, or a period of a monitoring window corresponding to an SSB is 20 ms.

In some embodiments, the configuration of the first CORESET includes at least one of: a multiplexing mode of an SSB and the first CORESET, a number of PRBs occupied by the first CORESET, a number of symbols occupied by the first CORESET, or a starting position of the first CORESET in a frequency domain.

In some embodiments, the first COREST includes CORESET 0, and/or the first SSS includes Type 0-PDCCH CSS.

In some embodiments, the first indication information includes pdcch-ConfigSIB1.

The first indication information is carried in MIB information, or the first indication information is configured through searchSpaceSIB1 or searchSpaceZero in PDCCH-ConfigCommon.

In some embodiments, an SCS corresponding to the first SSS is 480 kHz or 960 kHz.

Alternatively, a configuration μ of an SCS corresponding to the first SSS is 5 or 6.

In some embodiments, the communication unit may be a communication interface, a transceiver or an input-output interface of a communication chip or a system-on-chip. The processing unit may be one or more processors.

It should be understood that the network device 500 according to the embodiment of the present disclosure may correspond to the network device in the method embodiments of the present disclosure, and the above and other operations and/or functions of the respective units in the network device 500 are for implementing the corresponding flows of the network device in the method 300 illustrated in FIG. 10, which are not be elaborated herein again for the sake of brevity.

In the above technical solution, a solution for monitoring a PDCCH carrying SIB1 can be optimized by configuring a configuration (for example, a value of a parameter O and a value of a parameter M) of the SSS applicable for the high frequency system. Further, in the embodiments of the present disclosure, in the high frequency system, when the SCS is 480 kHz or 960 kHz, requirements on the processing capability for the terminal device can be reduced by enhancing an occasion for monitoring Type 0-PDCCH common search space (CSS) by the terminal device from two continuous slots to two continuous slot groups.

FIG. 13 is a schematic structural diagram of a communication device 600 provided by an embodiment of the present disclosure. The communication device 600 illustrated in FIG. 13 includes a processor 610. The processor 610 may call computer programs from a memory and run the computer programs to implement the methods in the embodiments of the present disclosure.

In some embodiments, as illustrated in FIG. 13, the communication device 600 may further include a memory 620. The processor 610 may call computer programs from the memory 620 and run the computer programs to implement the methods in the embodiments of the present disclosure.

The memory 620 may be a separate device independent of the processor 610 or may be integrated in the processor 610.

In some embodiments, as illustrated in FIG. 13, the communication device 600 may further include a transceiver 630. The processor 610 may control the transceiver 630 to communicate with other devices, and in particular to send or receive information or data to or from other devices.

The transceiver 630 may include a transmitter and a receiver. The transceiver 630 may further include antennas, and there may be one or more antennas.

In some embodiments, the communication device 600 may be specifically the network device in the embodiments of the present disclosure, and the communication device 600 may implement corresponding processes implemented by the network device in various methods of the embodiments of the present disclosure, which will not be elaborated herein again for the sake of brevity.

In some embodiments, the communication device 600 may be specifically the terminal device in the embodiments of the present disclosure, and the communication device 600 may implement corresponding processes implemented by the terminal device in various methods of the embodiments of the present disclosure, which will not be elaborated herein again for the sake of brevity.

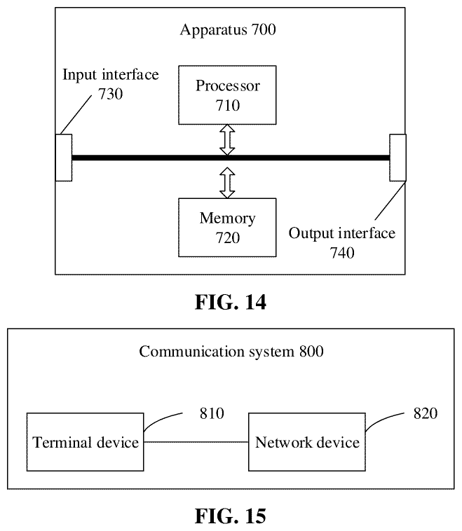

FIG. 14 is a schematic structural diagram of an apparatus according to an embodiment of the present disclosure. The apparatus 700 illustrated in FIG. 14 includes a processor 710. The processor 710 may call computer programs from a memory and run the computer programs to implement the methods in embodiments of the present disclosure.

In some embodiments, as illustrated in FIG. 14, the apparatus 700 may further include a memory 720. The processor 710 may call computer programs from the memory 720 and run the computer programs to implement the methods in embodiments of the present disclosure.

The memory 720 may be a separate device independent of the processor 710 or may be integrated in the processor 710.

In some embodiments, the apparatus 700 may further include an input interface 730. The processor 710 may control the input interface 730 to communicate with other devices or chips, and in particular to obtain information or data sent by other devices or chips.

In some embodiments, the apparatus 700 may further include an output interface 740. The processor 710 may control the output interface 740 to communicate with other devices or chips, and in particular to output information or data to other devices or chips.

In some embodiments, the apparatus may be applied to the network device in the embodiments of the present disclosure, and the apparatus may implement corresponding processes implemented by the network device in the various methods of the embodiments of the present disclosure, which will not be elaborated herein again for the sake of brevity.

In some embodiments, the apparatus may be applied to the terminal device in the embodiments of the present device, and the apparatus may implement corresponding processes implemented by the terminal device in the various methods of the embodiments of the present disclosure, which will not be elaborated herein again for the sake of brevity.

In some embodiments, the apparatus mentioned in the embodiment of the present disclosure may also be a chip. For example, it may be a system-level chip, a system chip, a chip system or a system-on-chip.

FIG. 15 is a schematic block diagram of a communication system 800 provided by an embodiment of the present disclosure. As illustrated in FIG. 15, the communication system 800 includes a terminal device 810 and a network device 820.

The terminal device 810 may be used for implementing the corresponding functions implemented by the terminal device in the above-mentioned methods, and the network device 820 may be used for implementing the corresponding functions implemented by the network device in the above-mentioned methods, which will not be elaborated herein again for the sake of brevity.

It should be understood that the processor in the embodiments of the present disclosure may be an integrated circuit chip having a signal processing capability. In implementation, the steps of the above method embodiments may be accomplished by integrated logic circuitry of hardware or instructions in the form of software in the processor. The processor may be a general purpose processor, a digital signal processor (DSP), an application specific integrated circuit (ASIC), a field programmable gate array (FPGA) or other programmable logic devices, discrete gates or transistor logic devices, or discrete hardware components. The methods, steps and logic block diagrams disclosed in embodiments of the present disclosure may be implemented or performed. The general purpose processor may be a microprocessor or the processor may be any conventional processor or the like. The steps of the methods disclosed in combination with the embodiments of the present disclosure may be directly embodied as the execution of the hardware decoding processor or the combined execution of the hardware and software modules in the decoding processor. The software modules may be located in a random access memory (RAM), a flash memory, a read-only memory (ROM), a programmable ROM (PROM) or an electrically erasable EPROM (EEPROM), a register and other storage medium mature in the art. The storage medium is located in the memory, and the processor reads the information in the memory and completes the steps of the method in combination with its hardware.

It is understood that the memory in embodiments of the present disclosure may be a volatile memory or a non-volatile memory or may include both volatile and non-volatile memory. The nonvolatile memory may be an ROM, a PROM, an erasable PROM (EPROM), an EEPROM, or a flash memory. The volatile memory may be an RAM which serves as an external cache. By way of illustration, but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that the memory of the systems and methods described herein is intended to include but not limited to these and any other suitable types of memory.

It should be understood that the memory described above is exemplary, but not limited, and, for example, the memory in embodiments of the present disclosure may also be an SRAM, a DRAM, an SDRAM, a DDR SDRAM, an ESDRAM, an SLDRAM, a DR RAM, etc. That is, the memory in embodiments of the present disclosure is intended to include but not limited to these and any other suitable types of memory.

The embodiments of the present disclosure further provide a computer-readable storage medium for storing computer programs.

In some embodiments, the computer-readable storage medium may be applied to the network device in the embodiments of the present disclosure, and the computer programs, when run on a computer, cause the computer to execute the corresponding flows implemented by the network device in the various methods of the embodiments of the present disclosure, which will not be elaborated herein again for the sake of brevity.

In some embodiments, the computer-readable storage medium may be applied to the terminal device in the embodiments of the present disclosure, and the computer programs, when run on a computer, cause the computer to execute corresponding flows implemented by the terminal device in the various methods of the embodiments of the present disclosure, which will not be elaborated herein again for the sake of brevity.

The embodiments of the present disclosure further provide a computer program product, including computer program instructions.

In some embodiments, the computer program product may be applied to the network device in the embodiments of the present disclosure, and the computer program instructions, when run on a computer, cause the computer to execute the corresponding flows implemented by the network device in the various methods of the embodiments of the present disclosure, which will not be elaborated herein again for the sake of brevity.

In some embodiments, the computer program product may be applied to the terminal device in the embodiments of the present disclosure, and the computer program instructions, when run on a computer, cause the computer to execute corresponding flows implemented by the terminal device in the various methods of the embodiments of the present disclosure, which will not be elaborated herein again for the sake of brevity.

The embodiments of the present disclosure further provide a computer program.

In some embodiments, the computer program may be applied to a network device in the embodiments of the present disclosure and the computer program, when run on a computer, causes the computer to execute the corresponding flows implemented by the network device in the various methods of the embodiments of the present disclosure, which will not be elaborated herein again for the sake of brevity.

In some embodiments, the computer program may be applied to a terminal device in the embodiments of the present disclosure and the computer program, when run on the computer, causes a computer to execute the corresponding flows implemented by the terminal device in the various methods of the embodiments of the present disclosure, which will not be elaborated herein again for the sake of brevity.

Those of ordinary skill in the art will appreciate that the various example units and algorithm steps described in combination with the embodiments disclosed herein may be implemented in electronic hardware or a combination of computer software and electronic hardware. Whether these functions are performed in hardware or software depends on the specific application and design constraints of the technical solution. Those skilled in the art may use different methods for particular applications to implement the described functionality, but such implementation should not be considered beyond the scope of the present disclosure.

Those skilled in the art will clearly appreciate that, for convenience and conciseness of description, the specific operating processes of the above described systems, apparatuses and units may refer to the corresponding processes in the aforementioned method embodiments, which will not be elaborated herein again for the sake of brevity.

In several embodiments provided herein, it should be understood that the disclosed systems, apparatuses and methods may be implemented in other ways. For example, the above-described embodiments of the devices are only schematic, for example, the division of the units is only a logical function division, and in practice, there may be another division mode. For example, multiple units or components may be combined or integrated into another system, or some features may be ignored or not performed. On the other hand, the coupling, direct coupling or communication connection between each other shown or discussed may be indirect coupling or communication connection through some interfaces, apparatus or units, and may be electrical, mechanical or other form.

The units illustrated as separate components may or may not be physically separated, and the components displayed as units may or may not be physical units, i.e. they may be located in one place, or may be distributed over a plurality of network units. Part or all of the units may be selected according to the actual needs to achieve the purpose of the embodiments.

In addition, various functional units in each embodiment of the present disclosure may be integrated in one processing unit, each unit may exist physically alone, or two or more units may be integrated in one unit.

The functions may be stored in a computer readable storage medium if implemented in the form of software functional units and sold or used as stand-alone products. With this understanding, the technical solution of the present disclosure in essence or in part contributing to the prior art may be embodied in the form of a software product. The computer software product is stored in a storage medium, which including instructions for causing a computer device (which may be a personal computer, a server, a network device, etc.) to perform all or part of the steps of the methods described in various embodiments of the present disclosure. The aforementioned storage medium includes a U disk, a removable hard disk, an ROM, an RAM, a magnetic disk or an optical disk and other medium capable of storing program codes.

The above-mentioned is only the specific embodiments of the present disclosure, but the scope of protection of the present disclosure is not limited thereto. Any technical person familiar with the technical field may easily think of changes or substitutions within the technical scope disclosed in the present disclosure, which should be covered within the scope of protection of the present disclosure. Therefore, the scope of protection of the present disclosure shall be subject to the scope of protection of the claims.

What is claimed is:

1. A method for wireless communication, comprising:
determining, by a terminal device, a monitoring occasion for a first search space set (SSS) based on first indication information, wherein the first indication information indicates at least one of a configuration of a first control-resource set (CORESET) or a configuration of the first SSS, and the first CORESET is associated with the first SSS; and
monitoring, by the terminal device, a first control channel based on the monitoring occasion for the first SSS, wherein
the configuration of the first SSS comprises at least one of: a value of a parameter O, a value of a parameter M, a number of first SSSs comprised in a slot group, or one or more starting positions of one or more first SSSs in a slot group,
the parameter O is used for determining a starting position of a monitoring window corresponding to a first synchronization signal block (SSB); and/or, the parameter M indicates a degree of overlap between a monitoring window corresponding to an i-th SSB and a monitoring window corresponding to an (i+1)-th SSB, i being an even number,
a monitoring window corresponding to an SSB corresponds to one or more continuous slot groups, and
a subcarrier spacing (SCS) corresponding to the first SSS is 480 kHz or 960 kHz; or a configuration μ of an SCS corresponding to the first SSS is 5 or 6.

2. The method of claim 1, wherein
the parameter M indicates the degree of overlap between the monitoring window corresponding to the i-th SSB and the monitoring window corresponding to the (i+1)-th SSB, and the monitoring window corresponding to the SSB corresponds to two continuous slot groups, and
M=½ indicates that two continuous slot groups corresponding to the i-th SSB completely overlap with two continuous slot groups corresponding to the (i+1)-th SSB; or
M=1 indicates that two continuous slot groups corresponding to the i-th SSB overlap with one of two continuous slot groups corresponding to the (i+1)-th SSB; or
M=2 indicates that two continuous slot groups corresponding to the i-th SSB do not overlap with two continuous slot groups corresponding to the (i+1)-th SSB at all, wherein a slot group comprises S slots, S being a positive integer.

3. The method of claim 1, wherein the parameter O is used for determining a starting slot no corresponding to the starting position of the monitoring window corresponding to the first SSB, wherein
$${n}_{0} = ( O \cdot {2}^{μ} ) mod {N}_{slotgroup}^{frame , μ} ;$$
μ representing a configuration of a subcarrier spacing (SCS) corresponding to the first SSS, Nₛₗₒₜ^{frame,μ} representing a number of slots comprised in a radio frame, and mod representing a modulo operation.

4. The method of claim 1, wherein the parameter O is used for determining a starting slot group n₀ corresponding to the starting position of the monitoring window corresponding to the first SSB, wherein
$${n}_{0} = ( O \cdot {2}^{μ} ) mod {N}_{slotgroup}^{frame , μ} ;$$
μ representing a configuration of an SCS corresponding to the first SSS, N_{slotgroup}^{frame,μ} representing a number of slot groups comprised in a radio frame, and mod representing a modulo operation.

5. The method of claim 4, wherein
$${N}_{slotgroup}^{frame , μ} = floor ( {N}_{slot}^{frame , μ} / S ) , or$$
$${N}_{slotgroup}^{frame , μ} = ceil ( {N}_{slot}^{frame , μ} / S ) ;$$
Nₛₗₒₜ^{frame,μ} representing a number of slots comprised in the radio frame, S representing a slot number of slots comprised in a slot group, S being a positive integer, floor representing round down, and ceil representing round up.

6. The method of claim 1, wherein
in case that an SCS corresponding to the first SSS is 480 kHz or 960 kHz, a period of the monitoring window corresponding to the SSB is 10 ms, or a period of the monitoring window corresponding to the SSB is 20 ms.

7. The method of claim 1, wherein
the configuration of the first CORESET comprises at least one of: a multiplexing mode of the SSB and the first CORESET, a number of physical resource blocks (PRBs) occupied by the first CORESET, a number of symbols occupied by the first CORESET, or a starting position of the first CORESET in a frequency domain; and/or
the first COREST comprises CORESET 0; and/or
the first SSS comprises Type 0-PDCCH CSS.

8. A terminal device, comprising:
a processor;
a memory for storing a computer program; and
a transceiver,
wherein the processor is configured to call the computer program stored in the memory and run the computer program to:
determine a monitoring occasion for a first search space set (SSS) based on first indication information, wherein the first indication information indicates at least one of a configuration of a first control-resource set (CORESET) or a configuration of the first SSS, and the first CORESET is associated with the first SSS; and
control the transceiver to monitor a first control channel based on the monitoring occasion for the first SSS, wherein
the configuration of the first SSS comprises at least one of: a value of a parameter O, a value of a parameter M, a number of first SSSs comprised in a slot group, or one or more starting positions of one or more first SSSs in a slot group,
the parameter O is used for determining a starting position of a monitoring window corresponding to a first synchronization signal block (SSB); and/or, the parameter M indicates a degree of overlap between a monitoring window corresponding to an i-th SSB and a monitoring window corresponding to an (i+1)-th SSB, i being an even number,
a monitoring window corresponding to an SSB corresponds to one or more continuous slot groups, and
a subcarrier spacing (SCS) corresponding to the first SSS is 480 kHz or 960 kHz; or a configuration μ of an SCS corresponding to the first SSS is 5 or 6.

9. The terminal device of claim 8, wherein
the parameter M indicates the degree of overlap between the monitoring window corresponding to the i-th SSB and the monitoring window corresponding to the (i+1)-th SSB, and the monitoring window corresponding to the SSB corresponds to two continuous slot groups, and
M=½ indicates that two continuous slot groups corresponding to the i-th SSB completely overlap with two continuous slot groups corresponding to the (i+1)-th SSB; or
M=1 indicates that two continuous slot groups corresponding to the i-th SSB overlap with one of two continuous slot groups corresponding to the (i+1)-th SSB; or
M=2 indicates that two continuous slot groups corresponding to the i-th SSB do not overlap with two continuous slot groups corresponding to the (i+1)-th SSB at all, wherein a slot group comprises S slots, S being a positive integer.

10. The terminal device of claim 8, wherein the parameter O is used for determining a starting slot n₀ corresponding to the starting position of the monitoring window corresponding to the first SSB, wherein
$${n}_{0} = ( O \cdot {2}^{μ} ) mod {N}_{slot}^{frame , μ} ;$$
μ representing a configuration of a subcarrier spacing (SCS) corresponding to the first SSS, Nₛₗₒₜ^{frame,μ} representing a number of slots comprised in a radio frame, and mod representing slot a modulo operation.

11. The terminal device of claim 8, wherein the parameter O is used for determining a starting slot group n₀ corresponding to the starting position of the monitoring window corresponding to the first SSB, wherein
$${n}_{0} = ( O \cdot {2}^{μ} ) mod {N}_{slotgroup}^{frame , μ} ;$$
μ representing a configuration of an SCS corresponding to the first SSS, N_{slotgroup}^{frame,μ} representing a number of slot groups comprised in a radio frame, and mod representing a modulo operation.

12. The terminal device of claim 11, wherein
$${N}_{slotgroup}^{frame , μ} = floor ( {N}_{slot}^{frame , μ} / S ) , or$$
$${N}_{slotgroup}^{frame , μ} = ceil ( {N}_{slot}^{frame , μ} / S ) ;$$
Nₛₗₒₜ^{frame,μ} representing a number of slots comprised in the radio frame, S representing a number of slots comprised in a slot group, S being a positive integer, floor representing round down, and ceil representing round up.

13. The terminal device of claim 8, wherein
in case that an SCS corresponding to the first SSS is 480 kHz or 960 kHz, a period of the monitoring window corresponding to the SSB is 10 ms, or a period of the monitoring window corresponding to the SSB is 20 ms.

14. The terminal device of claim 8, wherein
the first indication information comprises pdcch-ConfigSIB1, and
the first indication information is carried in master information block (MIB) information, or the first indication information is configured through searchSpaceSIB1 or searchSpace Zero in PDCCH-ConfigCommon.

15. A network device, comprising:
a processor;
a memory for storing a computer program; and
a transceiver,
wherein the processor is configured to call the computer program stored in the memory and run the computer program to:
determine first indication information, wherein the first indication information indicates at least one of a configuration of a first control-resource set (CORESET) or a configuration of a first search space set (SSS), and the first CORESET is associated with the first SSS; and
control the transceiver to transmit the first indication information to a terminal device, wherein
the configuration of the first SSS comprises at least one of: a value of a parameter O, a value of a parameter M, a number of first SSSs comprised in a slot group, or one or more starting positions of one or more first SSSs in a slot group,
the parameter O is used for determining a starting position of a monitoring window corresponding to a first synchronization signal block (SSB); and/or, the parameter M indicates a degree of overlap between a monitoring window corresponding to an i-th SSB and a monitoring window corresponding to an (i+1)-th SSB, i being an even number,
a monitoring window corresponding to an SSB corresponds to one or more continuous slot groups, and
a subcarrier spacing (SCS) corresponding to the first SSS is 480 kHz or 960 kHz; or a configuration μ of an SCS corresponding to the first SSS is 5 or 6.

16. The network device of claim 15, wherein
the parameter M indicates the degree of overlap between the monitoring window corresponding to the i-th SSB and the monitoring window corresponding to the (i+1)-th SSB, and the monitoring window corresponding to the SSB corresponds to two continuous slot groups, and
M=½ indicates that two continuous slot groups corresponding to the i-th SSB completely overlap with two continuous slot groups corresponding to the (i+1)-th SSB; or
M=1 indicates that two continuous slot groups corresponding to the i-th SSB overlap with one of two continuous slot groups corresponding to the (i+1)-th SSB; or
M=2 indicates that two continuous slot groups corresponding to the i-th SSB do not overlap with two continuous slot groups corresponding to the (i+1)-th SSB at all, wherein a slot group comprises S slots, S being a positive integer.

17. The network device of claim 15, wherein the parameter O is used for determining a starting slot n₀ corresponding to the starting position of the monitoring window corresponding to the first SSB, wherein
$${n}_{0} = ( O \cdot {2}^{μ} ) mod {N}_{slot}^{frame , μ} ;$$
representing a configuration of a subcarrier spacing (SCS) corresponding to the first SSS, Nₛₗₒₜ^{frame,μ} representing a number of slots comprised in a radio frame, and mod representing a modulo operation.

18. The network device of claim 15, wherein the parameter O is used for determining a starting slot group n₀ corresponding to the starting position of the monitoring window corresponding to the first SSB, wherein
$${n}_{0} = ( O \cdot {2}^{μ} ) mod {N}_{slotgroup}^{frame , μ} ;$$
μ representing a configuration of an SCS corresponding to the first SSS, N_{slotgroup}^{frame,μ} representing a number of slot groups comprised in a radio frame, and mod representing a modulo operation, wherein
$${N}_{slotgroup}^{frame , μ} = floor ( {N}_{slot}^{frame , μ} / S ) , or$$
$${N}_{slotgroup}^{frame , μ} = ceil ( {N}_{slot}^{frame , μ} / S ) ;$$
Nₛₗₒₜ^{frame,μ} representing a number of slots comprised in the radio frame, S representing a number of slots comprised in a slot group, S being a positive integer, floor representing round down, and ceil representing round up.

19. The network device of claim 15, wherein
in case that an SCS corresponding to the first SSS is 480 kHz or 960 kHz, a period of the monitoring window corresponding to the SSB is 10 ms, or a period of the monitoring window corresponding to the SSB is 20 ms.

20. The network device of claim 15, wherein
the configuration of the first CORESET comprises at least one of: a multiplexing mode of the SSB and the first CORESET, a number of physical resource blocks (PRBs) occupied by the first CORESET, a number of symbols occupied by the first CORESET, or a starting position of the first CORESET in a frequency domain; and/or
the first COREST comprises CORESET 0; and/or
the first SSS comprises Type 0-PDCCH CSS; and/or
the first indication information comprises pdcch-ConfigSIB1, and the first indication information is carried in master information block (MIB) information, or the first indication information is configured through searchSpaceSIB1 or searchSpaceZero in PDCCH-ConfigCommon.
